(19) United States
(12) Patent Application Publication
(10) Pub. No.: US 2023/0267652 A1
(43) Pub. Date: Aug. 24, 2023

(54) GENERATING ARTISTIC CONTENT FROM A TEXT PROMPT OR A STYLE IMAGE UTILIZING A NEURAL NETWORK MODEL

(71) Applicant: Adobe Inc., San Jose, CA (US)

(72) Inventors: Marian Lupascu, Bucharest Sector 3 (RO); Ryan Murdock, Salt Lake City, UT (US); Ionut Mironica, Bucharest (RO); Yijun Li, Seattle, WA (US)

(21) Appl. No.: 17/652,390

(22) Filed: Feb. 24, 2022

(51) Int. Cl. G06T 11/00; G06T 3/40

(52) U.S. Cl. CPC G06T 11/00; G06T 3/4046; G06T 3/4053; G06T 2210/36; G06T 2210/22

(57) ABSTRACT

The present disclosure relates to systems, methods, and non-transitory computer readable media that utilize an iterative neural network framework for generating artistic visual content. For instance, in one or more embodiments, the disclosed systems receive style parameters in the form a style image and/or a text prompt. In some cases, the disclosed systems further receive a content image having content to include in the artistic visual content. Accordingly, in one or more embodiments, the disclosed systems utilize a neural network to generate the artistic visual content by iteratively generating an image, comparing the image to the style parameters, and updating parameters for generating the next image based on the comparison. In some instances, the disclosed systems incorporate a superzoom network into the neural network for increasing the resolution of the final image and adding art details that are associated with a physical art medium (e.g., brush strokes).

### BACKGROUND

Recent years have seen significant advancement in hardware and software platforms for creating digital visual content. In particular, many conventional systems provide various tools that can be implemented for digitally creating and/or editing artistic visual content. For instance, many existing systems provide tools for creating artistic visual content based on an artistic style derived from a style prompt, such as a digital image.

Despite these advances, however, conventional content creation systems suffer from several technological shortcomings that result in inflexible and inaccurate operation. For instance, many conventional systems are inflexible in that they are typically limited to generating artistic visual content based on a digital image style prompt. Indeed, such systems are often incapable of incorporating artistic styles provided by style prompts of other forms into the creation process. While there do exist some systems that allow for the generation or manipulation of visual content utilizing other forms of style prompts, such as text prompts, these systems are often limited to creating photorealistic visual content rather than artistic visual content. Additionally, many conventional systems are limited to creating visual content from a single domain of content (e.g., faces, churches, cars, etc.).

In addition to flexibility concerns, conventional content creation systems often operate inaccurately. In particular, conventional systems often fail to accurately capture the artistic style provided by the style prompt within the generated visual content. For example, some conventional systems generate visual content by manipulating a content image. These systems, however, often fail to alter the structure of the content image in accordance with the style prompt. Indeed, many systems merely manipulate the content image to create minor variations in its features, such as variations in its color, texture, or background. Accordingly, these systems generate visual content that does not accurately reflect the prompted style.

These, along with additional problems and issues exist with regard to conventional content creation systems.

### SUMMARY

One or more embodiments described herein provide benefits and/or solve one or more of the foregoing or other problems in the art with systems, methods, and non-transitory computer-readable media that flexibly generates artistic visual content based on a style image and/or a text prompt utilizing a neural network framework. In particular, in one or more embodiments, the disclosed systems receive style parameters as input (e.g., via a list of style images, a list of text prompts, or a combination of style images and text prompts) and generate a wide range of artistic content, with varying degrees of detail, style and structure with a boost in generation speed. For instance, in some embodiments, the disclosed systems utilize a neural network framework that generates an artistic image in relation to the style parameters via an iterative optimization method. In some cases, the disclosed systems further receive a content image and create the artistic content by manipulating the content image based on the style parameters via the iterative optimization method. For example, in at least one implementation, the disclosed systems utilize the neural network framework to iteratively modify the structure of the content image and incorporate additional artistic details, such as painter-specific patterns or brush marks. Moreover, in one or more embodiments, the disclosed systems further enhance results by utilizing an artistic superzoom framework in the generative pipeline (e.g., to bring additional details such as patterns specific to painters, slight brush marks, etc.). In this manner, the disclosed systems flexibly generate artistic visual content from a variety of style prompt forms utilizing a neural network framework that accurately captures the prompted style in its output.

Additional features and advantages of one or more embodiments of the present disclosure are outlined in the following description.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which an artistic content generation system operates in accordance with one or more embodiments;

FIG. 2 illustrates an overview diagram of the artistic content generation system generating an artistic digital image in accordance with one or more embodiments;

FIG. 3 illustrates an overview of an architecture of an artistic image neural network in accordance with one or more embodiments;

FIG. 4 illustrates a diagram for transforming an intermediate digital image and a style digital image for comparison in accordance with one or more embodiments;

FIG. 5 illustrates an architecture of an artistic image neural network that implements an iterative process using hierarchical scaling to different resolutions in accordance with one or more embodiments;

FIGS. 6A-6C illustrate the architecture of an artistic superzoom neural network incorporated into an artistic image neural network in accordance with one or more embodiments;

FIG. 7A illustrates a diagram for utilizing fractal noise during a process for generating an artistic digital image in accordance with one or more embodiments;

FIG. 7B illustrates a diagram for utilizing an augmentation chain during a process for generating an artistic digital image in accordance with one or more embodiments;

FIG. 7C illustrates graphical representations representing the effects of using fractal noise and/or an augmentation chain in accordance with one or more embodiments;

FIG. 8 illustrates graphical representations reflecting experimental results regarding the effectiveness of the artistic content generation system in accordance with one or more embodiments;

FIG. 9 illustrates graphical representations reflecting additional experimental results regarding the effectiveness of the artistic content generation system in accordance with one or more embodiments;

FIG. 10 illustrate graphical representations reflecting further experimental results regarding the effectiveness of the artistic content generation system in accordance with one or more embodiments;

FIG. 11 illustrates an example schematic diagram of an artistic content generation system in accordance with one or more embodiments;

FIG. 12 illustrates a flowchart of a series of acts for generating an artistic digital image utilizing an artistic image neural network in accordance with one or more embodiments; and

FIG. 13 illustrates a block diagram of an exemplary computing device in accordance with one or more embodiments.

### DETAILED DESCRIPTION

One or more embodiments described herein include an artistic content generation system that flexibly and accurately generates artistic content from various style prompt utilizing a neural network framework. Indeed, in one or more embodiments, the artistic content generation system utilizes an artistic image neural network to generate artistic visual content by stylizing a content image with a list of text prompts, a list of image prompts, or a combination of both. Accordingly, in some embodiments, the artistic content generation system implements text-guided image generation or manipulation to create the artistic visual content. In one or more embodiments, the artistic content generation generates the artistic visual content utilizing a neural network framework having a generative adversarial network (GAN) architecture that incorporates artistic superzoom to increase the resolution of the content and create special artistic effects (e.g., painting effects). In some cases, the neural network framework provides an iterative optimization process that incorporates fractal noise with an augmentation chain to facilitate incorporation of the artistic style associated with the style prompt(s).

To provide an illustration, in one or more embodiments, the artistic content generation system generates, utilizing an artistic generative neural network, an initialized artistic digital image based on a learnable tensor. Further, the artistic content generation system determines, utilizing a multi-domain style encoder of the artistic generative neural network, one or more style encodings for one or more style parameters. The artistic content generation system updates parameters of the learnable tensor by comparing the initialized artistic digital image to the one or more style encodings. Based on the learnable tensor with the updated parameters, the artistic content generation system generates an artistic digital image utilizing the artistic generative neural network.

As mentioned above, in one or more embodiments, the artistic content generation system utilizes a neural network framework for generating an artistic digital image. In particular, in some cases, the artistic content generation system utilizes an artistic image neural network to generate the artistic digital image. In some implementations, the artistic image neural network includes various components, such as an artistic generative neural network, a learnable tensor, at least one artistic superzoom neural network, and one or more additional encoders.

In one or more embodiments, the artistic content generation system utilizes the artistic image neural network to generate an artistic digital image from one or more style parameters. In some cases, the artistic content generation system receives the one or more style parameter by receiving a style digital image (or list of style digital images), a style text prompt (or list of style text prompts), or a combination of both. In some cases, the artistic image neural network utilizes the artistic image neural network to encode the one or more style parameters (e.g., encode the list of style digital images and/or the list of style text prompts) into a common, multi-domain encoding space.

In some embodiments, the artistic content generation system generates an artistic digital image by generating an initialized artistic digital image from the learnable tensor utilizing the artistic image neural network. Moreover, in one or more embodiments, the artistic content generation system further compares the initialized artistic digital image to the received style parameter(s), such as by encoding the initialized artistic digital image into the multi-domain encoding space and comparing the encodings. Based on the comparison, the artistic content generation system updates the learnable tensor. The artistic content generation system utilizes the artistic image neural network to generate the artistic digital image from the updated learnable tensor.

In some cases, the artistic content generation system generates the artistic digital image via an iterative process. Indeed, in some implementations, the artistic content generation system utilizes the artistic image neural network to iteratively generate an intermediate artistic digital image from the learnable tensor, compare the intermediate artistic digital image to the style parameters, and update the learnable tensor based on the comparison. Accordingly, in some instances, the artistic image neural network outputs the artistic digital image after a set number of iterations. In some cases, the artistic content generation system implements a scale hierarchy through different resolutions via the iteration process. Moreover, in some implementations, the artistic image neural network utilizes fractal noise and/or an augmentation chain to increase the speed of convergence.

In one or more embodiments, the artistic content generation system utilizes an artistic superzoom neural network of the artistic image neural network to add additional details to the artistic digital image. For example, the artistic content generation system utilizes the artistic superzoom neural network to increase the resolution of the artistic digital image and/or incorporate art details associated with a physical visual medium (e.g., painting effects, such as brush strokes or other painter-specific artifacts).

Further, in one or more embodiments, the artistic content generation system generates the artistic digital image from another digital image (e.g., a digital image that is separate from the style digital images). In particular, the artistic content generation system utilizes content from the other digital image to generate the artistic digital image. For example, in some implementations, the artistic content generation system utilizes the other digital image to initialize the learnable tensor used in generating the artistic digital image.

The artistic content generation system provides several advantages over conventional systems. For example, the artistic content generation system improves the flexibility of implementing computing devices when compared to conventional systems. To illustrate, by generating an artistic digital image from a style digital image (or list of style digital images) and/or a style text prompt (or list of style text prompts), the artistic content generation system flexibly generates artistic visual content from a variety of style prompt forms. Additionally, the artistic content generation system can flexibly generate artistic visual content using content from a variety of domains, rather than being limited to a single domain as is typical under many conventional systems.

Additionally, the artistic content generation system can improve the accuracy of implementing computing devices when compared to conventional systems. In particular, the artistic content generation system can generate artistic visual content that accurately captures the artistic style provided via one or more style prompts. To illustrate, in some cases, the artistic content generation system utilizes an artistic image neural network to alter the structure of the content displayed in another digital image to generate an artistic digital image. In particular, the artistic image neural network alters the structure of the content in accordance with the one or more style prompts. Thus, the artistic content generation system more accurately aligns the artistic style of the generated visual content with the artistic style provided by the style prompt(s).

In addition, the artistic content generation system can also improve efficiency of implementing computing devices. In particular, by utilizing the proposed neural network framework, in some implementations. the artistic content generation system provides a boost in image generation speed and a corresponding reduction in computer resource requirements. For instance, as described in greater detail below, by utilizing fractal noise followed by stylization while using an augmentation chain, the artistic content generation system can significantly reduce the time and computing resources needed for convergence.

As illustrated by the foregoing discussion, the present disclosure utilizes a variety of terms to describe features and benefits of the artistic content generation system. Additional detail is now provided regarding the meaning of these terms. For example, as used herein, the term “artistic digital image” refers to modified digital visual content (e.g., that includes one or more modifications to add artistic features). In particular, in some embodiments, an artistic digital image refers to a modified digital image that features one or more artistic styles. To illustrate, in some cases, an artistic digital image includes content generated to include one or more artistic styles. In some implementations, an artistic digital image includes a non-photographic digital image. Relatedly, as used herein, the term “initialized artistic digital image” refers to an initial digital image generated in a process (e.g., an iterative process) for generating an artistic digital image. Similarly, as used herein, the term “intermediate artistic digital image” refers to an artistic digital image that is generated in a process (e.g., an iterative process) for generating an artistic digital image but is not the output of the process (e.g., not the final artistic digital image). Accordingly, in some cases, an initialized artistic digital image is an intermediate artistic digital image.

As used herein, the term “artistic encoding” refers to an encoding that corresponds to an artistic digital image. In particular, in some embodiments, an artistic encoding refers to an encoded value or an encoded set of values that represents at least a portion of an artistic digital image. To illustrate, in some cases, an artistic encoding includes an encoding generated from an artistic digital image.

Additionally, as used herein, the term “style parameter” refers to a parameter for creating an artistic digital image. In particular, in some embodiments, a style parameter refers to a patent or latent feature corresponding to an artistic digital image/text prompt (e.g., a feature that is to be included in an artistic digital image). To illustrate, in some cases, a style parameter includes a patent or latent feature associated with content or an artistic style to be incorporated within an artistic digital image. For instance, in some implementations, a style parameter includes an object, a color, a color scheme, a geometry, a landscape, or a theme or concept to be incorporated into an artistic digital image. Relatedly, as used herein, the term “style digital image” refers to a digital image that is associated with (e.g., includes) one or more style parameters to be incorporated into an artistic digital image. Further, as used herein, the term “style text prompt” refers to a text (e.g., a word, a sentence, or a paragraph) that includes (e.g., describes) one or more style parameters to be incorporated into an artistic digital image.

Further, as used herein, the term “style encoding” refers to an encoding that corresponds to a style parameter. In particular, in some embodiments, a style encoding refers to an encoded value or an encoded set of values that represents at least a portion of a style parameter. To illustrate, in some cases, a style encoding includes an encoding generated from a style digital image or a style text prompt.

As used herein, the term “multi-domain encoding space” refers to a latent encoding space for encodings associated with multiple domains. In particular, in some embodiments, a multi-domain encoding space refers to an encoding space that contains (or is capable of containing) encodings generated from data that is associated with least one of multiple different domains. For instance, in some cases, a multi-domain encoding space includes an encoding space that contains (or is capable of containing) style encodings generated from digital images (e.g., style digital images) and style encodings generated from text (e.g., style text prompts).

Relatedly, as used herein, the term “multi-domain style encoder” refers to an encoder that generates encodings within a multi-domain encoding space. In particular, in some embodiments, a multi-domain style encoder refers to an encoder that generates style encodings (e.g., from text and/or digital images) within a multi-domain encoding space. In some cases, a multi-domain style encoder includes one or more component neural network encoders. For example, in some cases, a multi-domain style encoder includes a neural network image encoder and a neural network text encoder.

As used herein, the term “neural network” refers to a type of machine learning model, which can be tuned (e.g., trained) based on inputs to approximate unknown functions used for generating the corresponding outputs. In particular, in some embodiments, a neural network refers to a model of interconnected artificial neurons (e.g., organized in layers) that communicate and learn to approximate complex functions and generate outputs based on a plurality of inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial neural network, a graph neural network, or a multi-layer perceptron. In some embodiments, a neural network includes a combination of neural networks or neural network components.

Additionally, as used herein, the term “artistic image neural network” refers to a computer-implemented neural network that generates artistic digital images. In particular, in some embodiments, an artistic image neural network refers to a computer-implemented neural network that generates an artistic digital image based on one or more style parameters and/or another digital image that includes content for generating the artistic digital image. To illustrate, in some cases, an artistic image neural network includes a neural network framework that implements an iterative process for generating an artistic digital image in accordance with one or more style parameters.

In some cases, an artistic image neural network includes an artistic generative neural network. As used herein, the term “artistic generative neural network” includes a computer-implemented generative neural network that generates artistic digital images. For example, in some cases, an artistic generative neural network includes a computer-implemented generative neural network that includes an encoder-decoder neural network architecture for generating artistic digital images (e.g., an intermediate artistic digital image and/or a final artistic digital image).

In some implementations, an artistic image neural network includes one or more artistic superzoom neural networks. As used herein, the term “artistic superzoom neural network” refers to a computer-implemented neural network that increases the resolution of a digital image, such as an artistic digital image or a digital image having content for creating an artistic digital image. In some implementations, an artistic superzoom neural network includes a computer-implemented neural network that adds, to an artistic digital image, one or more art details associated with a physical visual medium (e.g., brush strokes or other painter-specific artifacts).

In some cases, an artistic image neural network includes a learnable tensor. As used herein, the term “learnable tensor” refers to a learnable dimensional data structure. In particular, in some embodiments, a learnable tensor includes a dimensional data structure having one or more parameters (e.g., values) that are changeable. In some embodiments, a learnable tensor corresponds to encodings generated by an encoder of an artistic generative neural network or the encoding space in which such encodings are generated.

As used herein, the term “augmentation chain” refers to a computer-implemented process for modifying a digital image, such as an artistic digital image. In particular, in some embodiments, an augmentation chain refers to a sequence of actions that change a digital image. To illustrate, in some implementations, an augmentation chain refers to a sequence of one or more transformation operations applied to a digital image. Relatedly, as used herein, the term “transformation operation” refers to an operation that modifies one or more aspects of a digital image. For instance, in some embodiments, a transformation operation includes, but is not limited to, one of a resize operation, a crop operation, a perspective operation, an image flip operation, or a noise operation.

Additionally, as used herein the term “fractal noise” refers to noise associated with a digital image. In particular, in some embodiments, fractal noise refers to digital data that affects patent or latent characteristics of a digital image. For instance, in some cases, fractal noise includes digital data that is added to a digital image to affect the patent or latent characteristics of the digital image.

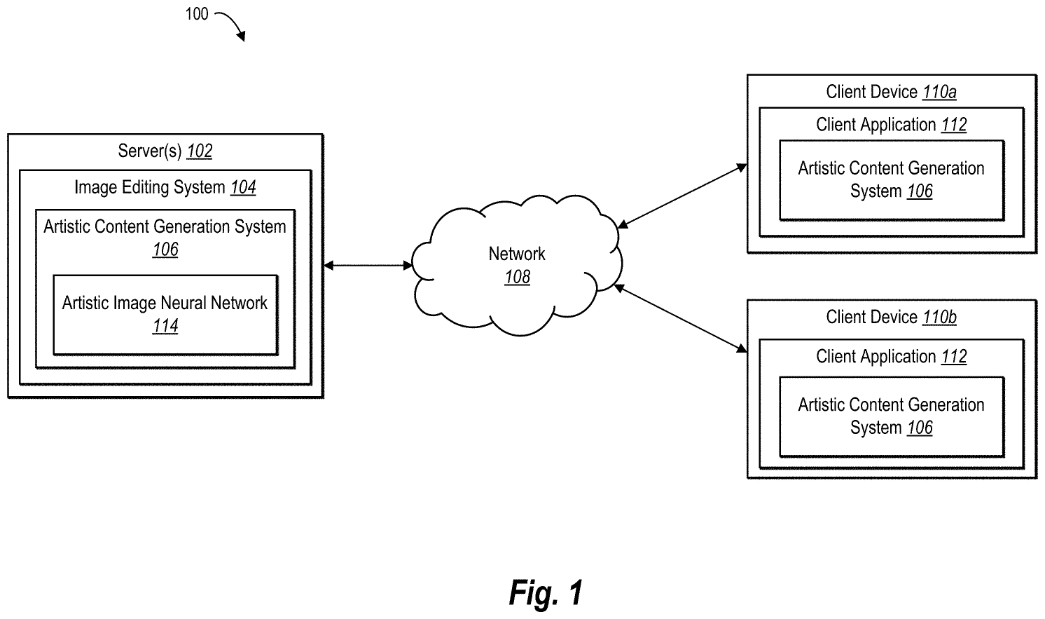

Additional detail regarding the artistic content generation system will now be provided with reference to the figures. For example, FIG. 1 illustrates a schematic diagram of an exemplary system environment (“environment”) 100 in which an artistic content generation system 106 operates. As illustrated in FIG. 1, the environment 100 includes a server(s) 102, a network 108, and client devices 110a-110b.

Although the environment 100 of FIG. 1 is depicted as having a particular number of components, the environment 100 is capable of having any number of additional or alternative components (e.g., any number of servers, client devices, or other components in communication with the artistic content generation system 106 via the network 108). Similarly, although FIG. 1 illustrates a particular arrangement of the server(s) 102, the network 108, and the client devices 110a-110b, various additional arrangements are possible.

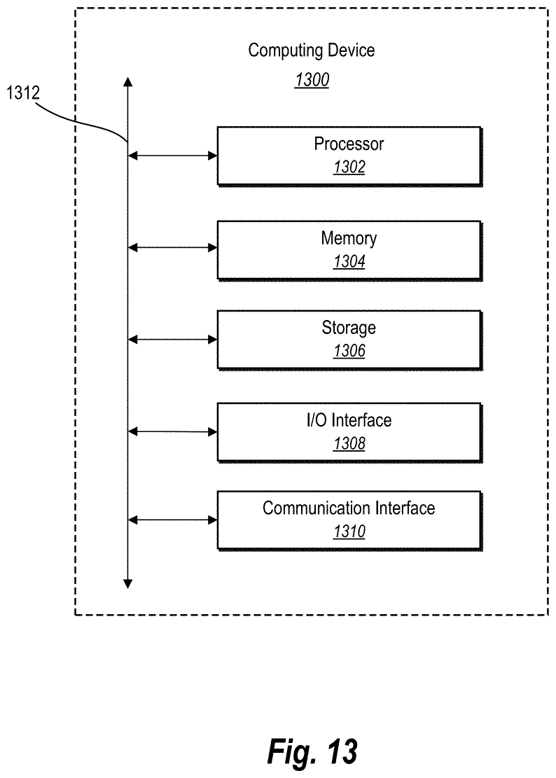

The server(s) 102, the network 108, and the client devices 110a-110b are communicatively coupled with each other either directly or indirectly (e.g., through the network 108 discussed in greater detail below in relation to FIG. 13). Moreover, the server(s) 102 and the client devices 110a-110b include one of a variety of computing devices (including one or more computing devices as discussed in greater detail with relation to FIG. 13).

As mentioned above, the environment 100 includes the server(s) 102. In one or more embodiments, the server(s) 102 generates, stores, receives, and/or transmits data including neural networks, digital images, and texts. In one or more embodiments, the server(s) 102 comprises a data server. In some implementations, the server(s) 102 comprises a communication server or a web-hosting server.

In one or more embodiments, the image editing system 104 provides functionality by which a client device (e.g., a user of one of the client devices 110a-110b) generates, edits, manages, and/or stores digital images. For example, in some instances, a client device sends a digital image to the image editing system 104 hosted on the server(s) 102 via the network 108. The image editing system 104 then provides many options that the client device. may use to edit the digital image, store the digital image, and subsequently search for, access, and view the digital image. Further, in some cases, the image editing system 104 provides one or more options that the client device may use to create an artistic digital image utilizing the digital image.

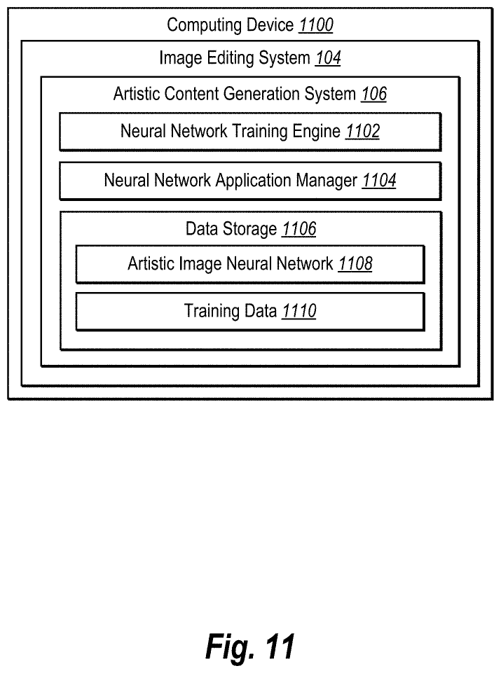

Additionally, the server(s) 102 include the artistic content generation system 106. In one or more embodiments, via the server(s) 102, the artistic content generation system 106 generates an artistic digital image utilizing an artistic image neural network 114. For example, in one or more embodiments, the artistic content generation system 106, via the server(s) 102, implements an iterative process for generating an artistic digital image in accordance with one or more embodiments. In some cases, via the server(s) 102, the artistic content generation system 106 receives a digital image that includes particular content and generates the artistic digital image based on the content of the digital image utilizing the artistic image neural network 114. Example components of the artistic content generation system 106 will be described below with regard to FIG. 11.

In one or more embodiments, the client devices 110a-110b include computing devices that can access, edit, modify, store, and/or provide, for display, digital images, such as artistic digital images. For example, the client devices 110a-110b include smartphones, tablets, desktop computers, laptop computers, head-mounted-display devices, or other electronic devices. The client devices 110a-110b include one or more applications (e.g., the client application 112) that can access, edit, modify, store, and/or provide, for display, digital images, such as artistic digital images. For example, in some embodiments, the client application 112 includes a software application installed on the client devices 110a-110b. In other cases, however, the client application 112 includes a web browser or other application that accesses a software application hosted on the server(s) 102.

The artistic content generation system 106 can be implemented in whole, or in part, by the individual elements of the environment 100. Indeed, as shown in FIG. 1 the artistic content generation system 106 can be implemented with regard to the server(s) 102 and/or at the client devices 110a-110b. In particular embodiments, the artistic content generation system 106 on the client devices 110a-110b comprises a web application, a native application installed on the client devices 110a-110b (e.g., a mobile application, a desktop application, a plug-in application, etc.), or a cloud-based application where part of the functionality is performed by the server(s) 102.

In additional or alternative embodiments, the artistic content generation system 106 on the client devices 110a-110b represents and/or provides the same or similar functionality as described herein in connection with the artistic content generation system 106 on the server(s) 102. In some implementations, the artistic content generation system 106 on the server(s) 102 supports the artistic content generation system 106 on the client devices 110a-110b.

For example, in some embodiments, the server(s) 102 train one or more machine-learning models described herein (e.g., the artistic image neural network 114). The artistic content generation system 106 on the server(s) 102 provides the one or more trained machine-learning models to the artistic content generation system 106 on the client devices 110a-110b for implementation. Accordingly, although not illustrated, in one or more embodiments the client devices 110a-110b utilize the artistic image neural network 114 to generate artistic digital images.

In some embodiments, the artistic content generation system 106 includes a web hosting application that allows the client devices 110a-110b to interact with content and services hosted on the server (s) 102. To illustrate, in one or more implementations, the client devices 110a-110b accesses a web page or computing application supported by the server (s) 102. The client devices 110a-110b provides input to the server(s) 102 (e.g., a style prompt and/or an input digital image). In response, the artistic content generation system 106 on the server(s) 102 utilizes the artistic image neural network 114 to generate an artistic digital image. The server(s) 102 then provides the artistic digital image to the client devices 110a-110b.

In some embodiments, though not illustrated in FIG. 1, the environment 100 has a different arrangement of components and/or has a different number or set of components altogether. For example, in certain embodiments, the client devices 110a-110b communicates directly with the server(s) 102, bypassing the network 108. As another example, the environment 100 includes a third-party server comprising a content server and/or a data collection server.

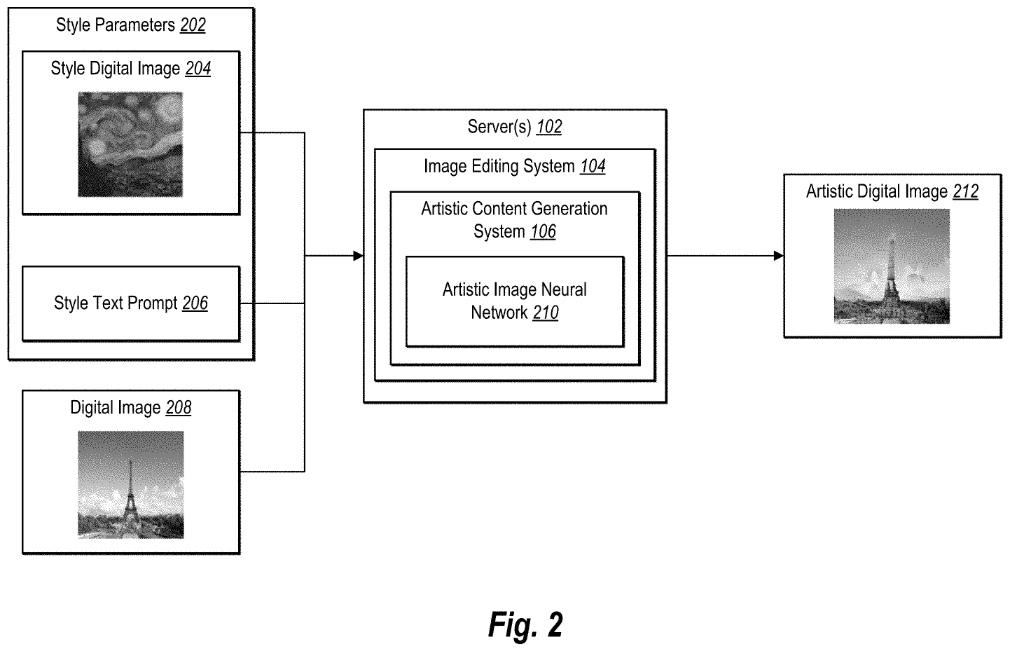

As mentioned above, the artistic content generation system 106 generates an artistic digital image. FIG. 2 illustrates an overview diagram of the artistic content generation system 106 generating an artistic digital image in accordance with one or more embodiments.

As shown in FIG. 2, the artistic content generation system 106 receives style parameters 202. In particular, as illustrated, the artistic content generation system 106 receives the style parameters 202 by receiving a style digital image 204 and a style text prompt 206. As previously mentioned, however, the artistic content generation system 106 receives one of a style digital image or a style text prompt (rather than both) in some embodiments. Further, in some implementations, the artistic content generation system 106 receives multiple style digital images and/or multiple style text prompts as the style parameters 202. Thus, the artistic content generation system 106 receives the style parameters 202 by receiving various combinations of style digital images and style text prompts in some embodiments.

In some cases, the artistic content generation system 106 receives the style parameters 202 from a client device. For example, in some implementations, the artistic content generation system 106 receives a communication from a client device containing the style digital image 204 and/or the style text prompt 206. In some cases, however, the artistic content generation system 106 receives an indication of the style parameters 202 and retrieves the style parameters 202 based on the indication. For example, in some cases, the artistic content generation system 106 stores a style digital image locally or at a remote storage location and retrieves the style digital image from storage in response to receiving an indication that the style digital image has been selected.

As further shown in FIG. 2, the artistic content generation system 106 receives a digital image 208. In some cases, the digital image 208 includes content on which an artistic digital image is to be based. For instance, in some implementations, the digital image 208 includes one or more foreground objects to include in the artistic digital image or a background to include in the artistic digital image. Similar to the style parameters 202, the artistic content generation system 106 receives the digital image 208 from a client device or retrieves the digital image 208 from storage in various embodiments.

It should be understood, however, that the digital image 208 is optional in some embodiments. In other words, in some implementations, the artistic content generation system 106 generates an artistic digital image without use of a digital image that includes base content. Distinctions between the process for generating an artistic digital image with or without a digital image having base content will be discussed in more detail below.

Additionally, as shown in FIG. 2, the artistic content generation system 106 utilizes an artistic image neural network 210 to analyze the style parameters 202 and the digital image 208. Based on the analysis of the style parameters 202 and the digital image 208, the artistic content generation system 106 generates an artistic digital image 212. In one or more embodiments, the artistic digital image 212 includes one or more artistic styles associated with the style parameters 202. In particular, the artistic digital image 212 includes one or more patent or latent artistic features or characteristics provided by the style parameters 202. Further, in some cases, the artistic digital image 212 includes content from the digital image 208. For example, in some cases, the artistic content generation system 106 generates the artistic digital image 212 to include at least some of the content from the digital image 208 as modified in accordance with the style parameters 202. To illustrate, in some cases, the artistic content generation system 106 modifies the structure of the content of the digital image 208 in generating the artistic digital image 212.

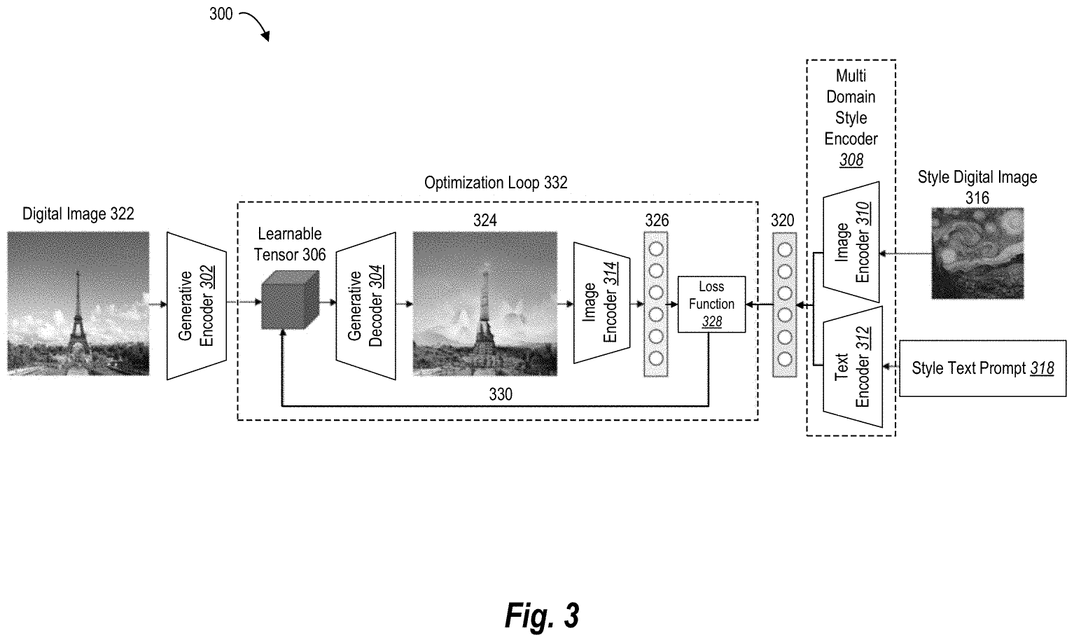

As previously mentioned, the artistic content generation system 106 utilizes an artistic image neural network to generate an artistic digital image. FIGS. 3-6C illustrate diagrams for utilizing an artistic image neural network to generate an artistic digital image. In particular, FIGS. 3-6C illustrate various components of and operations performed by an artistic image neural network in accordance with one or more embodiments.

For example, FIG. 3 illustrates an overview of an architecture of an artistic image neural network 300 in accordance with one or more embodiments. As shown in FIG. 3, the artistic image neural network 300 includes an artistic generative neural network having an encoder 302 and a decoder 304. The artistic image neural network 300 further includes a learnable tensor 306. Additionally, the artistic image neural network 300 includes a multi-domain style encoder 308 that is composed of a neural network image encoder 310 and a neural network text encoder 312. Further, as shown, the artistic image neural network 300 includes an additional neural network image encoder 314. In some cases, the neural network image encoder 310 and the additional neural network image encoder 314 are the same network. In other words, in some implementations, the artistic image neural network 300 utilizes one neural network image encoder for the neural network image encoders 310, 314.

As illustrated by FIG. 3, the artistic content generation system 106 provides one or more style parameters to the artistic image neural network 300. In particular, as shown, the artistic content generation system 106 provides a style digital image 316 and a style text prompt 318 to the multi-domain style encoder 308 of the artistic image neural network 300. The artistic content generation system 106 utilizes the multi-domain style encoder 308 to project the style digital image 316 and the style text prompt 318 into a multi-domain encoding space. Specifically, the artistic content generation system 106 utilizes the neural network image encoder 310 to project the style digital image 316 into the multi-domain encoding space and utilizes the neural network text encoder 312 to project the style text prompt 318 into the multi-domain encoding space. Thus, the artistic content generation system 106 utilizes the multi-domain style encoder 308 to determine style encodings 320 from the style parameters associated with the style digital image 316 and the style text prompt 318.

By utilizing the multi-domain style encoder 308 to generate style encodings from a style digital image and/or a style text prompt, the artistic content generation system 106 enables implementing computing devices to operate more flexibly than conventional systems. Indeed, the artistic content generation system 106 enables an implementing computing device to utilize style parameters associated with a wider variety of style prompts when compared to other systems.

In one or more embodiments, the artistic content generation system 106 utilizes, as the multi-domain style encoder 308, an encoder that includes the cross-lingual-multimodal-embedding model and the image-embedding model described in U.S. patent application Ser. No. 17/075,450 filed on Oct. 20, 2020, entitled GENERATING EMBEDDINGS IN A MULTIMODAL EMBEDDING SPACE FOR CROSS-LINGUAL DIGITAL IMAGE RETRIEVAL, the contents of which are expressly incorporated herein by reference in their entirety. In some cases, the artistic content generation system 106 utilizes, as the multi-domain style encoder 308, the Contrastive Language-Image Pre-training (CLIP) model described by Alec Radford et al., Learnable Transferable Visual Models from Natural Language Supervision, ICML, 2021, arXiv:2103.00020, which is incorporated herein by reference in its entirety.

As further shown by FIG. 3, the artistic content generation system 106 provides a digital image 322 having content to include in the resulting artistic digital image to the artistic image neural network 300. In particular, the artistic content generation system 106 provides the digital image 322 to the encoder 302 of the artistic generative neural network 300. The artistic content generation system 106 utilizes the encoder 302 to define the learnable tensor 306 based on the digital image 322. For example, in some cases, the artistic content generation system 106 utilizes the encoder 302 to initialize the parameters (e.g., values or encodings) of the learnable tensor 306 based on the digital image 322. In some cases, the artistic content generation system 106 improves the flexibility of implementing computing devices by facilitating the creation of artistic digital images using content from a wider variety of domains when compared to other systems.

As previously mentioned, in some embodiments, the artistic content generation system 106 utilizes the artistic image neural network 300 to generate an artistic digital image without the use of a digital image having content for the artistic digital image. In such cases, the artistic content generation system 106 initializes the parameters of the learnable tensor 306 by selecting a point (e.g., a randomized or semi-randomized point) within an encoding space associated with the artistic generative neural network.

As shown in FIG. 3, the artistic content generation system 106 utilizes the decoder 304 of the artistic generative neural network to generate an initialized artistic digital image 324 based on the learnable tensor 306. In one or more embodiments, the artistic content generation system 106 utilizes, as the artistic generative neural network, at least one of the generative models described by Patrick Esser et al., Taming Transformers for High-Resolution Image Synthesis, CVRP, 2020, arXiv:2012.09841; Andrew Brock et al., Large Scale GAN Training for High Fidelity Natural Image Synthesis, 2018, arXiv:1809.11096; Ting-Yun Chang and Chi-Jen Lu, TinyGAN. Distilling BigGAN for Conditional Image Generation, ACC, 2020, arXiv:2009.13829; and Prafulla Dhariwal and Alex Nichol, Diffusion Models Beat GANs on Image Synthesis, 2021, arXiv:2105.05233, all of which are incorporated herein by reference in their entirety.

Further, as shown, the artistic content generation system 106 utilizes the additional neural network image encoder 314 to project the initialized artistic digital image 324 into the multi-domain encoding space. In particular, the artistic content generation system 106 utilizes the additional neural network image encoder 314 to generate artistic encodings 326 from the initialized artistic digital image 324.

In one or more embodiments, the artistic content generation system 106 utilizes, as the additional neural network image encoder 314, the image-embedding model described in U.S. patent application Ser. No. 17/075,450. In some cases, the artistic content generation system 106 utilizes, as the additional neural network image encoder 314, the neural network image encoder of the CLIP model described by Alec Radford et al.

Further, as illustrated, the artistic content generation system 106 compares the initialized artistic digital image 324 to the style parameters associated with the style digital image 316 and the style text prompt 318. For example, as shown, the artistic content generation system 106 compares the artistic encodings 326 generated from the initialized artistic digital image 324 and the style encodings 320 generated from the style digital image 316 and the style text prompt 318. To illustrate, as shown, the artistic content generation system 106 compares the artistic encodings 326 and the style encodings 320 utilizing a loss function 328. In one or more embodiments, the artistic content generation system 106 utilizes a style loss function defined as follows:

$${ℒ}_{s t y l e} = \frac{2}{\vert I \vert} {\sum }_{i ∈ I} {arcsin ( \frac{1}{2} {‖ Enco {d}_{i m a g e} ( ( t ) ) - ( i ) ‖}_{2} )}^{2} + \frac{2}{\vert P \vert} {\sum }_{p ∈ P} {arcsin ( \frac{1}{2} {‖ Enco {d}_{i m a g e} ( ( t ) ) - ( p ) ‖}_{2} )}^{2} \qquad ( 1 )$$

In equation 3, \tilde{·} represents the operation of normalizing a vector, where the artistic content generation system 106 normalizes a vector \tilde{v} as follows

$$\tilde{v} = \frac{v}{max ( {‖ v ‖}_{2} , ∈ )} , \\ ∈ = 1 {0}^{- 12} .$$

Additionally, in equation 1, l represents the set of style digital images, P represents the set of style text prompts, Encod_{image}(·) represents the function that encodes an image into the multi-domain encoding space (e.g., as implemented by the neural network image encoder 310 and the additional neural network image encoder 314), and Encodₜₑₓₜ(·) represents the function that encodes a style text prompt into the multi-domain encoding space (e.g., as implemented by the neural network text encoder 312). Further, t represents the learnable tensor 306 and Decod(·) represents the function that generates an artistic digital image from the learnable tensor 306 (e.g., as implemented by the decoder 304 of the artistic generative neural network).

As shown in FIG. 3, the artistic content generation system 106 back propagates the loss determined via the loss function 328 to the learnable tensor 306 (as shown by the line 330). In particular, the artistic content generation system 106 determines one or more gradients with respect to the learnable tensor 306 via back propagation. In one or more embodiments, the artistic content generation system 106 updates the parameters of the learnable tensor 306 using the determined gradient(s). For example, in some cases, the artistic content generation system 106 updates the parameters in relation to the gradient(s) by decreasing the partial derivatives (taken from the gradient) of the parameter on each component.

As indicated by FIG. 3, the artistic image neural network 300 implements an iterative optimization loop 332. In particular, the artistic image neural network 300 iteratively generates an intermediate digital image from the learnable tensor 306, projects the intermediate digital image into the multi-domain encoding space, compares the artistic encodings to the style encodings 320 via the loss function 328, and updates the parameters of the learnable tensor 306 based on the comparison. Thus, at each iteration after the first iteration, the artistic image neural network 300 generates a new intermediate artistic digital image based on the learnable tensor 306 with the parameters as updated from the previous iteration. In some embodiments, the artistic image neural network 300 uses the last iteration to generate the artistic digital image (e.g., the final artistic digital image) from the learnable tensor 306 with the most recent parameter updates. Thus, in one or more embodiments, the artistic image neural network 300 utilizes the iterative optimization loop 332 to iteratively increase the degree to which the artistic digital image generated from the learnable tensor 306 incorporates the style parameters.

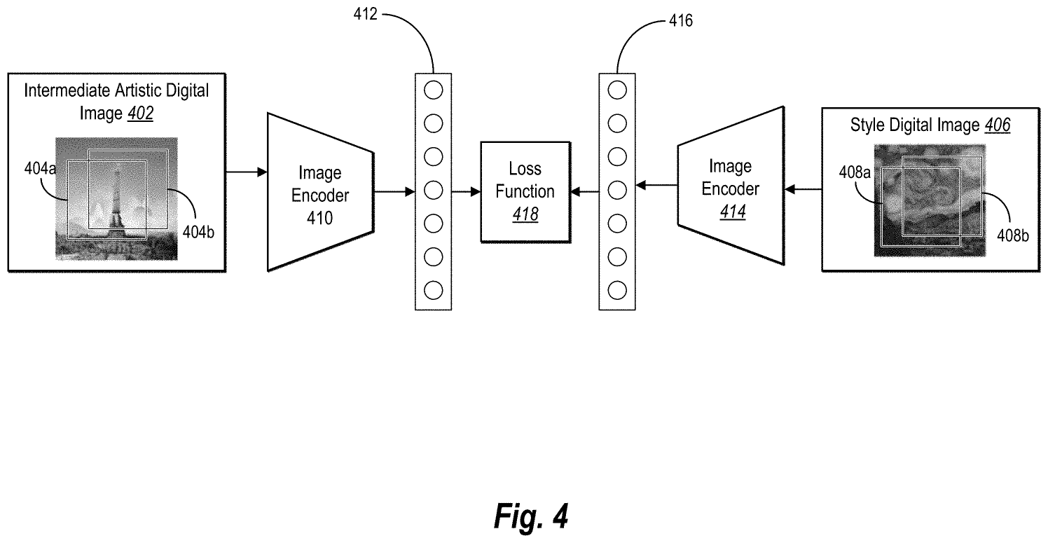

In one or more embodiments, the artistic content generation system 106 modifies/transforms the intermediate artistic digital images (such as the initialized artistic digital image) generated from the learnable tensor and the style digital image before comparing them. FIG. 4 illustrates a diagram for transforming an intermediate digital image and a style digital image for comparison in accordance with one or more embodiments.

For example, as shown in FIG. 4, the artistic content generation system 106 crops an intermediate artistic digital image 402 utilizing crops of variable cropping size and/or variable cropping offset (e.g., the crops 404a-404b). Thus, in some cases, the artistic content generation system 106 generates a set of transformed intermediate artistic digital images from the intermediate artistic digital image 402.

Similarly, as shown in FIG. 4, the artistic content generation system 106 crops a style digital image 406 utilizing crops of variable cropping size and/or variable cropping offset (e.g., the crops 408a-408b). Thus, in cases, the artistic content generation system 106 generates a set of transformed style digital images from the style digital image 406.

In one or more embodiments, the artistic content generation system 106 utilizes different cropping sizes and/or different cropping offsets for cropping the intermediate artistic digital image 402 and the style digital image 406. For example, in some cases, the artistic content generation system 106 randomizes the selection of the cropping size and/or the cropping offset. In some cases, however, the artistic content generation system 106 utilizes the same the cropping sizes and/or cropping offsets for cropping the intermediate artistic digital image 402 and the style digital image 406.

Further, in some embodiments, the artistic content generation system 106 generates crops of the style digital image 406 once during generation of an artistic digital image. For example, in some cases, the artistic content generation system 106 creates one set of transformed style digital images and utilizes the same set for every iteration implemented by the artistic image neural network to generate the artistic digital image. In some cases, however, the artistic content generation system 106 generates a new set of transformed style digital images for every iteration. Likewise, in one or more embodiments, the artistic content generation system 106 generates a new set of transformed intermediate artistic digital images for every iteration as the artistic image neural network generates a new intermediate artistic digital image at each iteration. In some instances, the artistic content generation system 106 generates two sets of transformed intermediate artistic digital images for every iteration (as will be shown with reference to equation 2).

As further shown in FIG. 4, the artistic content generation system 106 utilizes a neural network image encoder 410 (e.g., the neural network image encoder 314 discussed above with reference to FIG. 3) of the artistic image neural network to generate artistic encodings 412 from the set of transformed intermediate artistic digital images (e.g., the crops of the intermediate artistic digital image 402). Further, the artistic content generation system 106 utilizes a neural network image encoder 414 (e.g., the neural network image encoder 310 discussed above with reference to FIG. 3) of the multi-domain style encoder of the artistic image neural network to generate style encodings 416 from the set of transformed style digital images (e.g., the crops of the style digital image 406). In one or more embodiments, the artistic content generation system 106 resizes the crops so that they are of the size corresponding to the input of the respective encoder.

Accordingly, in one or more embodiments, the artistic content generation system 106 compares the artistic encodings 412 and the style encodings 416 using the loss function 418 (e.g., the loss function 328 discussed above with reference to FIG. 3). For instance, in some implementations, the artistic content generation system 106 utilizes a style loss function defined as follows:

$${ℒ}_{style} = \frac{2}{\vert I \vert \cdot \vert A \vert \cdot {\sum }_{i ∈ I} \vert {B}_{i} \vert} {\sum }_{i ∈ I} {\sum }_{( a , b ) ∈ A \times {B}_{i}} {arcsin ( \frac{1}{2} {‖ Enco {d}_{i m a g e} ( ( a ) ) - ( b ) ‖}_{2} )}^{2} + \frac{2}{\vert P \vert \cdot \vert C \vert} {\sum }_{p ∈ P} {\sum }_{c ∈ C} {arcsin ( \frac{1}{2} {‖ Enco {d}_{i m a g e} ( ( c ) ) - ( p ) ‖}_{2} )}^{2} \qquad ( 2 )$$

The style loss of equation 2 differs from the style loss of equation 1 in that it accommodates the cropped digital images projected into the multi-domain encoding space. For example, in equation 2, A and C represent the sets of transformed intermediate artistic digital images. In one or more embodiments, the artistic content generation system 106 generates the sets represented by A and C independently from one another. Further, in equation 2, Bᵢ represents the set of transformed style digital images. As suggested, in some cases, the set Bᵢ remains constant through the process of generating the artistic digital image.

In one or more embodiments, then artistic content generation system 106 further utilizes one or more additional loss functions to facilitate control of the amount of content to keep in the final artistic digital image (e.g., the content from the digital image provided to the encoder of the artistic generative neural network). In particular, in some cases, the artistic content generation system 106 utilizes the additional loss function(s) to ensure a one-to-one correspondence to each iteration between the intermediate results and the content of the original digital image. For example, in one or more embodiments, the artistic content generation system 106 further utilizes a pixel loss function defined as follows:

$${ℒ}_{p i x e l} = \frac{1}{2 C {D}_{1} {D}_{2}} {\sum }_{c = 1}^{C} {\sum }_{i = 1}^{{D}_{1}} {\sum }_{j = 1}^{{D}_{2}} {( t [ c , i , j ] - E n c o {d}_{g e n} ( O ) [ c , i , j ] )}^{2} \qquad ( 3 )$$

In equation 3, k[c,i,j]∀c∈1̅,̅C̅, x∈1̅,̅D̅₁̅, y∈1̅,̅D̅₂̅ represents the codec at position i,j in the tensor k of dimensions C×D₁×D₂. Further, C represents the dimensionality of codes in the latent space of the artistic generative neural network encoder, and D₁×D₂ represents the dimensionality of a digital image of W×H pixels in the latent space. In some cases, D₁=[W/2^{m}] and D₂=[H/2^{m}] where m represents the number of down-sampling blocks. Further, O represents the digital image having the content for creating the artistic digital image (having dimensions W×H), and Encod_{gen}(·) represents the function that encodes a digital image into the encoding space of the learnable tensor (e.g., as implemented by the encoder of the artistic generative neural network). In other words, t=Encod_{gen}(O).

In some embodiments, the artistic content generation system 106 further utilizes a perceptual loss function defined as follows:

[symbol]

_{perceptual}=LPIPS(Decod(t),O) (4)

In equation 4, LPIPS(·) refers to the feature extractor utilized in determining the perceptual loss. In some embodiments, the artistic content generation system 106 utilizes, as the feature extractor, the Visual Geometry Group 19 (VGG19) model described by Karen Simonyan and Andrew Zisserman, Very Deep Convolutional Networks for Large-Scale Image Recognition, CVPR, 2015, arXiv:1409.1556, which is incorporated herein by reference in its entirety.

Thus, in one or more embodiments, the artistic content generation system 106 combines one or more of the loss functions defined by equation 2 (or equation 1) and equations 3-4 for comparing encodings within the multi-domain encoding space. For example, in some implementations, the artistic content generation system 106 utilizes the loss function defined as follows:

[symbol]

= [symbol] _{style}+wₚᵢₓₑₗ [symbol] ₚᵢₓₑₗ+w_{perceptual} [symbol] _{perceptual} (5)

In equation 5, wₚᵢₓₑₗ and w_{perceptual} represent weights to be applied to the pixel loss and the perceptual loss, respectively. In one or more embodiments, wₚᵢₓₑₗ and w_{perceptual} are configurable. In other words, in some cases, the artistic content generation system 106 determines wₚᵢₓₑₗ and w_{perceptual} based on inputs (e.g., received via a client device). Further, in some embodiments, where a digital image having content for the artistic digital image is not used, artistic content generation system 106 sets wₚᵢₓₑₗ and w_{perceptual} equal to zero.

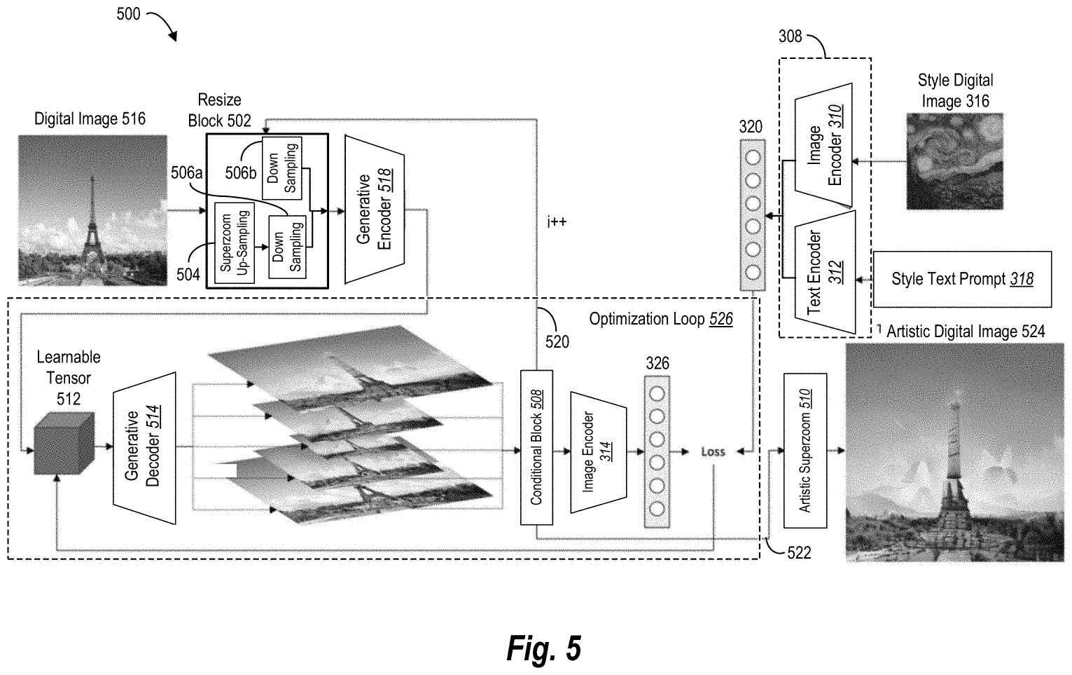

As previously mentioned, in some embodiments, the artistic content generation system 106 utilizes an artistic image neural network to generate an artistic digital image via an iterative process that implements a hierarchical scaling to different resolutions. FIG. 5 illustrates an architecture of an artistic image neural network that implements an iterative process using a hierarchical scaling to different resolutions in accordance with one or more embodiments.

As shown in FIG. 5, the artistic image neural network 500 is similar to the artistic image neural network 300 discussed in reference to FIG. 3 with some notable differences. In particular, the artistic image neural network 500 includes a resize block 502 that is composed of an artistic superzoom neural network 504 (labeled “superzoom up-sampling”) and down-sampling blocks 506a-506b. Further, the artistic image neural network 500 includes a conditional block 508 and an additional artistic superzoom neural network 510 (labeled “artistic superzoom).

In one or more embodiments, the artistic content generation system 106 utilizes hierarchical scaling to different resolutions to stylize the learnable tensor 512 to a variable scale of resolutions. For instance, in some cases, the artistic content generation system 106 defines such a scaling as follows:

S={((r₁_{ᵢ}×r₂_{ᵢ}),fᵢ)}ᵢ₌₁ⁿ (6)

Equation 6 indicates that the scale hierarchy S includes n resolutions in which the decoder 514 of the artistic generative neural network generates a color image of size (r₁_{ᵢ}×r₂_{ᵢ}), and fᵢ represents the number of iterations performed until moving to the next resolution with the index i+1. In one or more embodiments, using the scale hierarchy defined by equation 6, the artistic image neural network 500 implements an optimization process (e.g., the process of generating an artistic digital image) as will now be described.

In one or more embodiments, the artistic image neural network 500 initializes the learnable tensor 512 with a digital image 516 having content for the artistic digital image—having resized the digital image 516 to the resolution (r₁_{ᵢ}×r₂_{ᵢ}) pixels. In particular, in some embodiments, the artistic content generation system 106 resizes the digital image 516 using the resize block 502. Further, the artistic image neural network 500 initializes the learnable tensor 512 by projecting the digital image 516 into an encoding space using an encoder 518 of the artistic generative neural network. As mentioned above, where no digital image having content for the artistic digital image is used, the artistic image neural network 500 initializes the learnable tensor 512 by selecting a point in the encoding space associated with the artistic generative neural network. In one or more embodiments, for initialization, the learnable tensor 512 includes a size of

$$( C \times \frac{{r}_{{1}_{1}}}{{2}^{m}} \times \frac{{r}_{{2}_{1}}}{{2}^{m}} )$$

where C represents dimensionality of codes in the encoding space of the artistic generative neural network and m represents the number of down-sampling blocks. In one or more embodiments, after initialization, the artistic image neural network 500 performs f₁ iterations of stylization.

In one or more embodiments, the artistic image neural network 500 performs a super resolution operation at each resizing if fᵢ₊₁fᵢ∀∈1̅,̅n̅−̅1̅ to provide additional enhancements of details in the intermediate results (e.g., the intermediate artistic digital images) and implicitly in the final result. Thus, in one or more embodiments, t=Encod_{gen}(SR(Decod(t))) where Encod_{gen}(·) and Decod(·) represents the encoder 518 and decoder 514, respectively, of the artistic generative neural network, and SR(·) represents the super resolution operation (e.g., as implemented by the artistic superzoom neural network 504 of the resize block 502.

In other words, in one or more embodiments, the artistic content generation system 106 utilizes the artistic image neural network 500 to initialize the learnable tensor 512 (e.g., based on the digital image 516 or by selecting a point in the encoding space associated with the learnable tensor 512). The artistic content generation system 106 further utilizes the artistic image neural network 500 to perform a first set of optimization iterations (e.g., via the optimization loop 526) to generate a first set of intermediate artistic digital images at a first resolution of the scale hierarchy. Additionally, the artistic content generation system 106 utilizes the artistic image neural network 500 to resize the intermediate artistic digital image produced by the last iteration of the first resolution to a second resolution via the resize block 502. Further, the artistic content generation system 106 utilizes the artistic image neural network 500 to perform a second set of optimization iterations (e.g., via the optimization loop 526) to generate a second set of intermediate artistic digital images at this second resolution. The artistic image neural network 500 similarly operates, iterating through all the resolutions of the scale hierarchy.

In one or more embodiments, the artistic image neural network 500 utilizes the conditional block 508 to change the resolution after exhausting the number of iterations for the current resolution of the scale hierarchy. In particular, the artistic image neural network 500 utilizes the conditional block 508 to send the intermediate artistic digital image produced by the last iteration for the current resolution to the resize block 502 (as shown by line 520).

At the final iteration for the last resolution of the scale hierarchy, the artistic image neural network 500 generates the artistic digital image 524 that will be provided as output. In one or more embodiments, at the final iteration for the last resolution, the artistic image neural network 500 utilizes the conditional block 508 to send the artistic digital image produced from the last iteration to the additional artistic superzoom neural network 510 (as shown by the line 522).

In one or more embodiments, the number of iterations for each resolution of the scale hierarchy is configurable. In some cases, the number of resolutions used for the scale hierarchy is configurable. Further, in some instances, each resolution used for the scale hierarchy is configurable.

In one or more embodiments, the artistic content generation system 106 utilizes the additional artistic superzoom neural network 510 of the artistic image neural network 500 to increase the resolution of the artistic digital image 524 and to incorporate art details associated with a physical visual medium (e.g., painting effects, such as brush strokes or other painter-specific artifacts).

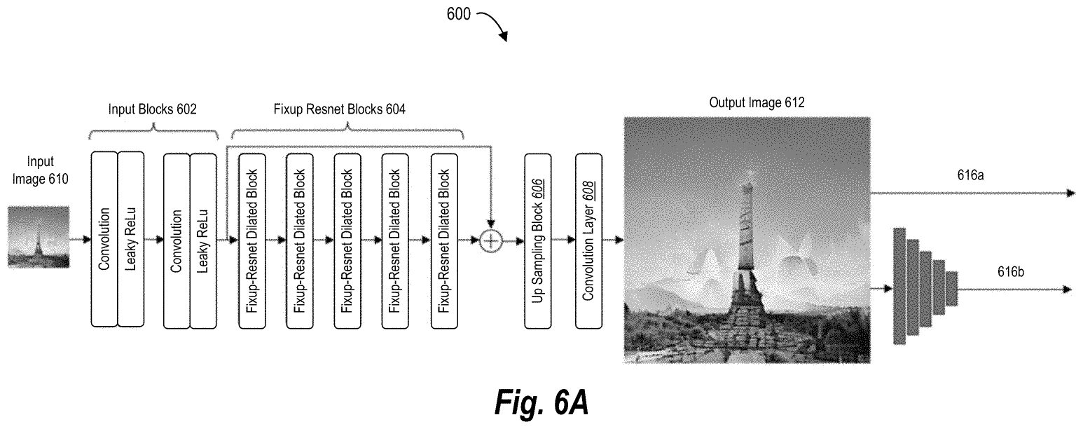

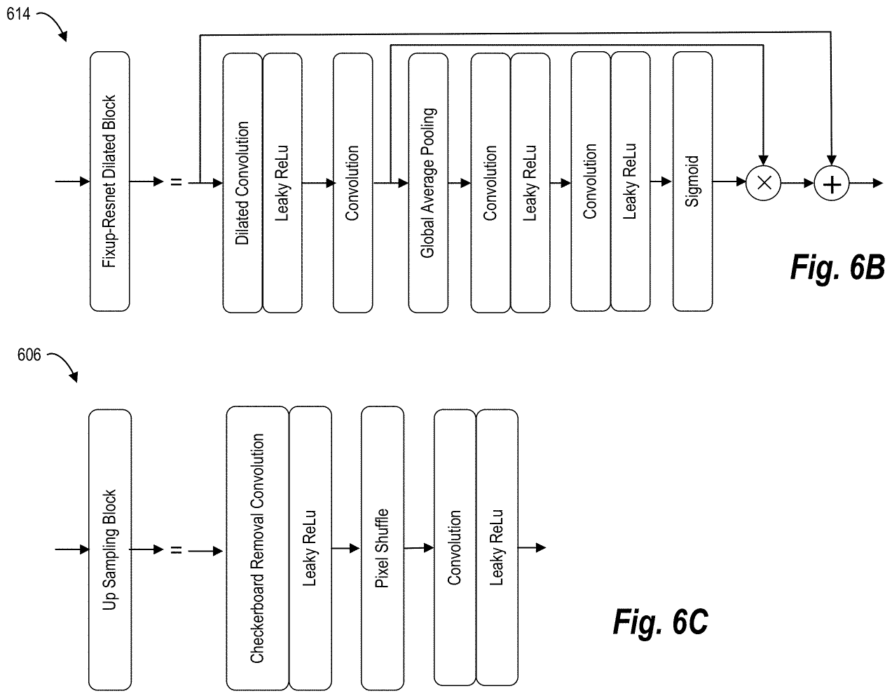

In one or more embodiments, the artistic superzoom neural network 504 of the resize block 502 and the additional artistic superzoom neural network 510 include similar architectures, which will be discussed in more detail below with reference to FIGS. 6A-6C. In some cases, the artistic superzoom neural network 504 and the additional artistic superzoom neural network 510 operate with natural scales rather than rational scales. Accordingly, in one or more embodiments, artistic superzoom neural network 504 and the additional artistic superzoom neural network 510 implement the up-sampling operation as follows:

$$SR ( I ) = {Resize}_{( {r}_{{1}_{i + 1}} \times {r}_{{2}_{i + 1}} )} ( {SZ}_{\times 2} ( I ) ) \qquad ( 6 )$$

In equation 6, Resize_{(a×b)}(I) represents the operation of resizing the image I to the dimensions (a×b) and SZ_{×2}(I) is the output from the artistic superzoom neural network that increases the resolution of the image I twice.

Thus, in one or more embodiments, the artistic content generation system 106 utilizes an artistic image neural network to iteratively utilize one or more style parameters to generate an artistic digital image. In particular, the artistic content generation system 106 utilizes the style encodings generated from the one or more style parameters to generate the artistic digital image. Accordingly, in some embodiments, the algorithm and acts described with reference to FIGS. 4-5 comprise the corresponding structure for performing a step for iteratively utilizing one or more style encodings to generate an artistic digital image from a digital image. Further, in some embodiments, the neural network architecture described with reference to FIGS. 4-5 comprises the corresponding structure for performing a step for iteratively utilizing the one or more style encodings to generate an artistic digital image from the digital image.

FIGS. 6A-6C illustrate the architecture of an artistic superzoom neural network incorporated into an artistic image neural network in accordance with one or more embodiments. As mentioned above, in some cases, the artistic content generation system 106 utilizes multiple artistic superzoom neural networks within an artistic image neural network to increase the resolution of a particular image and/or to add art details associated with a physical visual medium at various points of the process for generating an artistic digital image.

As shown in FIG. 6A, an artistic superzoom neural network 600 includes input blocks 602, fixup resnet dilated blocks 604, an up-sampling block 606, and a convolutional layer 608. As indicated by FIG. 6A, the artistic superzoom neural network 600 implements the up-sampling block 606 with r number of repetitions. In one or more embodiments, r is configurable. In one or more embodiments, r represents the up-sampling scale. Thus, in some embodiments, the artistic content generation system 106 utilizes the artistic superzoom neural network 600 to generate an output image 612 having increased resolution compared to an input image 610. In one or more embodiments, the lines 616a-616b represent the losses utilized in training the artistic superzoom neural network 600, which will be discussed in more detail below.

FIG. 6B illustrates the architecture of a fixup resent dilated block 614 in accordance with one or more embodiments. In one or more embodiments, each fixup resnet dilated block from the fixup resnet dilated blocks 604 includes the architecture shown in FIG. 6B. FIG. 6C illustrates the architecture of up-sampling block 606 in accordance with one or more embodiments.

In some embodiments, the artistic superzoom neural network operates more efficiently than models employed by many conventional systems as the artistic superzoom neural network operates without batch normalization. Accordingly, the speed of the artistic superzoom neural network is relatively faster because there are fewer operations to perform, and the model can be trained with small batches on a basic GPU. Further, in some cases, the artistic superzoom neural network includes one or more attention mechanisms that improve the quality of the output, providing more accurate results when compared to many conventional systems. Further, in one or more embodiments, the artistic content generation system 106 operates without a particular compression rate (while many conventional systems do), allowing the artistic content generation system 106 to reconstruct details regardless of compression rate and leading to a model that has a substantially reduced size compared to the models of many conventional systems.

In one or more embodiments, the artistic content generation system 106 trains the artistic superzoom neural network(s) using an image dataset of famous paintings (e.g., paintings from Van Gogh, Monet, Friedrich, etc.). In some cases, the artistic content generation system 106 extracts patches from the images in the dataset and utilizes the patches to perform the training. Further, in some cases, the artistic content generation system 106 augments the paintings using random rotation and/or random resizing transformation operations on both input images and synthetic images. In some cases, the artistic content generation system 106 further applies random intensities of the synthetic images.

In one or more embodiments, artistic content generation system 106 utilizes Gᵣ to represent an artistic superzoom neural network that increases the size of an input image 2^{r} times. If I is an image of size W×H×3, then Gᵣ(I) is an image of size 2^{r}W×2^{r}H×3. In some instances, during the training process, the artistic content generation system 106 subjects each image T from the image dataset of size 2^{r}W×2^{r}H×3 to a Gaussian filter followed by a down-sampling to the size of W×H×3, resulting in the image \hat{T}. In some cases, the artistic content generation system 106 provides \hat{T} as input for training.

In one or more embodiments, the artistic content generation system 106 utilizes one or more loss functions for training the artistic superzoom neural network. For example, in some cases, the artistic content generation system 106 utilizes a loss function composed of a combination of loss functions. For instance, in some cases, the artistic content generation system 106 utilizes a pixel loss function defined as follows:

$${L}_{p i x e l} = \frac{1}{{2}^{2 r} W H} {\sum }_{x = 1}^{{2}^{r} W} {\sum }_{y = 1}^{{2}^{r} H} {( {G}_{r} ( \hat{T} [ x , y ] ) - T [ x , y ] )}^{2} \qquad ( 7 )$$

In equation 7, l[x,y]∀x∈1̅,̅W̅, y∈1̅,̅H̅ represents the pixel at position x, y in the image I of dimension W×H pixels. In some instances, the pixel loss of equation 7 represents a mean squared error (MSE) loss between the resulting image and the ground truth. In some cases, the artistic content generation system 106 utilizes the loss function represented by equation 7 to preserve the overall structure of the original image so that the output is not a degraded version of the input and a similar version of it.

In some cases, the artistic content generation system 106 further utilizes a perceptual loss function defined as follows:

$${L}_{perceptual} = \frac{1}{{2}^{2 r} {W}_{l} {H}_{l} {C}_{l}} {\sum }_{l ∈ S} {\sum }_{x = 1}^{{W}_{l}} {\sum }_{y = 1}^{{H}_{l}} {\sum }_{z = 1}^{{C}_{l}} \vert {ϕ}_{l} ( {G}_{r} ( \hat{T} ) ) - {ϕ}_{l} ( T ) \vert \qquad ( 8 )$$

In equation 8, ϕₗ(I) represents the feature map after the ReLU function with the number l in the feature-extractor that receives, as input, the image I. In some cases, the artistic content generation system 106 utilizes, as the feature extractor described by Karen Simonyan, referenced above. In one or more embodiments, ϕₗ(I) has the dimensions Wₗ×Hₗ and Cₗ channels, S={2,4,8,12,16}. In one or more embodiments, the artistic content generation system 106 utilizes the loss function represented by equation 8 to preserve the content of the input image but also to transfer a part of the training set style to the output.

In some embodiments, the artistic content generation system 106 further utilizes an adversarial loss function defined as:

L_{adversarial}=− [symbol] _{R˜Y}[log(σ(D(R)))]− [symbol] _{F˜X}[log(1−σ(D(Gᵣ(F))))] (9)

In equation 9, the first term represents the discriminator, and the second term represents the generator. Further, σ(x)=1/1+e^{-x} is the sigmoid function, Y is the set of high-resolution painting images in the dataset, X is the set of painting images in the dataset that is subject to the Gaussian filter and down-sampling with reduction rate of 2^{r}. In one or more embodiments, the artistic content generation system 106 utilizes the generator G(·) to attempt to generate high-resolution images similar to the real ones (e.g., the ground truths) and utilizes the discriminator D(·) to try to distinguish between the resulting fake G(F) image, F∈X and the corresponding real painting image R∈Y. In some cases, the artistic content generation system 106 utilizes the loss function represented by equation 9 to generate images that are similar to real-world art, enhancing particular art details.

In one or more embodiments, the artistic content generation system 106 combines the loss functions represented by equations 7-9 into an overall loss function as follows:

$$ℒ = {w}_{1} {L}_{p i x e l} + {w}_{2} {L}_{perceptual} + {w}_{3} {L}_{adversarial} , where \{ \begin{matrix}{w}_{1} = 1 \\ {w}_{2} = 2 \\ {w}_{3} = 0.01\end{matrix} \qquad ( 10 )$$

Though equation 10 illustrates particular values for each of the weights, it should be understood that the weights vary in various embodiments. For instance, in some implementations, the weights are configurable.

Thus, in the artistic content generation system 106 utilizes the loss function represented by equation 10 (or one of the loss functions represented by equations 7-9 or a combination of the loss functions represented by equations 7-9) to train an artistic superzoom neural network. In particular, the artistic content generation system 106 utilizes the loss function(s) to iteratively modify parameters of the superzoom artistic neural network, enabling the superzoom artistic neural network to reduce the error by which it produces outputs.

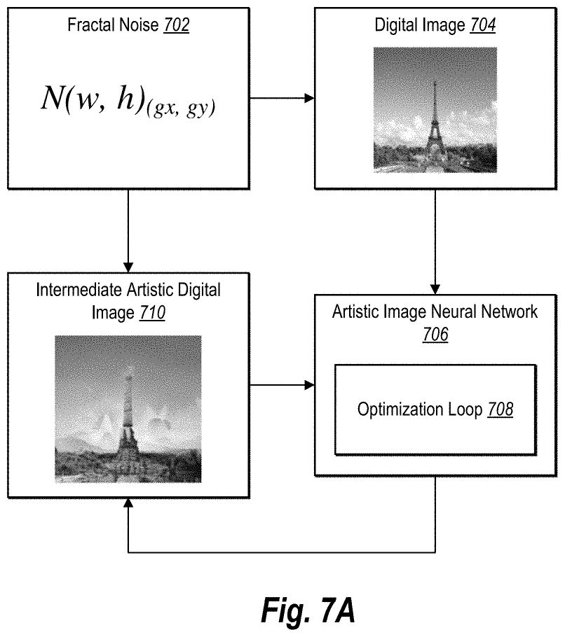

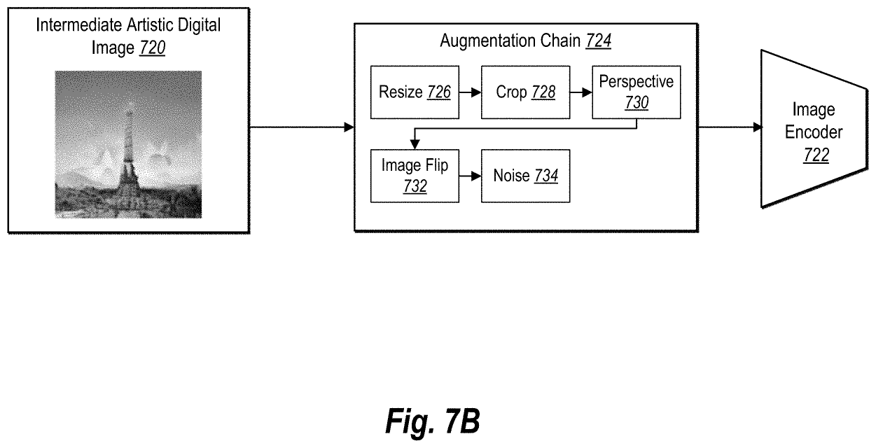

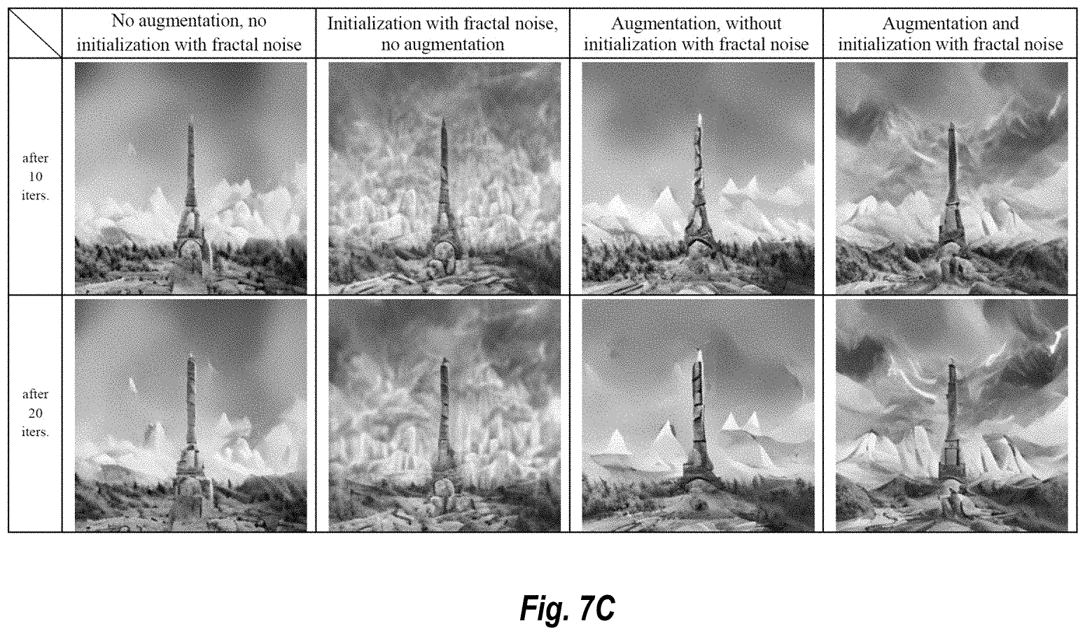

As mentioned, in one or more embodiments, the artistic content generation system 106 performs one or more additional operations via the artistic image neural network to speed up convergence. In particular, the artistic image neural network implements the one or more additional operations to increase the degree to which the style parameters are incorporated into the generated images at each iteration. FIGS. 7A-7B illustrate diagrams for utilizing one or more additional operations to increase the speed of convergence in accordance with one or more embodiments. FIG. 7C illustrates graphical representations of the effects of these operations in accordance with one or more embodiments.

For example, FIG. 7A illustrates a diagram for utilizing fractal noise during the process for generating an artistic digital image in accordance with one or more embodiments. Indeed, as shown in FIG. 7A, the artistic content generation system 106 adds fractal noise 702 to the digital image 704 having content at the beginning of the process for generating an artistic digital image. For example, in some embodiments, the artistic content generation system 106 adds the fractal noise 702 to the alpha channel of the digital image 704. In one or more embodiments, the artistic content generation system 106 defines the fractal noise 702 added to the digital image 704 as follows:

$${N ( w , h )}_{( g x , g y )} = {\sum }_{i = 1}^{n} {A}^{i - 1} \cdot {PN ( w , h )}_{( gx \cdot {l}^{i - 1} , gy \cdot {l}^{i - 1} )} \qquad ( 11 )$$

In equation 11, (w,h) represents the size of the generated noise, (gx, gy) represents the size of the grid used in PN—Perlin Noise (a gradient noise with at least some degree of coherent structure. Further, n=[log₂ max(w,h)]−3 represents the number of octaves used. In one or more embodiments, the artistic content generation system 106 determines the degree of detail of the final noise by obtaining the different octaves of the Perlin Noise. In some cases, each octave includes a degree of detail, and the artistic content generation system 106 utilizes 1, which represents lacunarity, to determine how much detail is added to each octave by controlling the size of the gradient grid in the Perlin Noise. Further, A represents the amplitude, indicating the importance of each octave in the final result.

As shown in FIG. 7A, the artistic content generation system 106 passes the digital image 704 with the fractal noise 702 to the artistic image neural network 706. As discussed above with reference to FIG. 5, the artistic image neural network 706 utilizes the digital image 704 to generate a set of intermediate artistic digital images via a set of iterations of an optimization loop 708. At the last iteration of the set of iterations (e.g., the last iteration for the current resolution), the artistic image neural network 706 generates the intermediate artistic digital image 710.

As further shown in FIG. 7A, the artistic content generation system 106 adds the fractal noise 702 to the intermediate artistic digital image 710 and passes the intermediate artistic digital image 710 with the fractal noise 702 back to the artistic image neural network 706 for further processing. Accordingly, in some implementations, the artistic content generation system 106 also adds fractal noise to the generated image at each up-sampling or down-sampling in the scale hierarchy. Though FIG. 7A shows adding the fractal noise 702 before an image is passed to the artistic image neural network 706, the artistic content generation system 106 adds the fractal noise 702 during or after the resizing process in some cases.

FIG. 7B illustrates a diagram for utilizing an augmentation chain during the process for generating an artistic digital image in accordance with one or more embodiments. In particular, as shown in FIG. 7B, the artistic content generation system 106 passes an intermediate artistic digital image 720 that is to be encoded by a neural network image encoder 722 through an augmentation chain 724. The artistic content generation system 106 utilizes the augmentation chain 724 to modify the intermediate artistic digital image 720 with one or more transformation operations.

As shown in FIG. 7B, the augmentation chain 724 includes a resize operation 726 (e.g., for randomly resizing each dimension independently), a crop operation 728, a perspective operation 730, an image flip operation 732 (e.g., to flip the image horizontally), and a noise operation 734 (e.g., to add random Gaussian noise). The augmentation chain 724 contains additional or fewer transformation operations in various embodiments. Further, though FIG. 7B illustrates a particular sequence of transformation operations, the artistic content generation system 106 utilizes various sequences in different embodiments. In some cases, the artistic content generation system 106 passes the intermediate artistic digital image 720 through the augmentation chain 724 and subsequently generates the set of transformed intermediate artistic digital images as discussed above with reference to FIG. 4. In some cases, the artistic content generation system 106 passes the set of transformed intermediate artistic digital images through the augmentation chain 724.

In one or more embodiments, the artistic content generation system 106 utilizes fractal noise and an augmentation chain to remove regular surfaces from the images used in the generative process, eliminating the problem of vanishing gradients experienced by many conventional systems. Indeed, in some instances, the artistic content generation system 106 utilizes the fractal noise to generate artifacts and then uses the augmentation chain to transform the artifacts into details, increasing the speed of the optimization.

FIG. 7C illustrates graphical representations reflecting the effects of fractal noise and an augmentation chain on the process of generating an artistic digital image in accordance with one or more embodiments. In particular, FIG. 7C illustrates the artistic digital image generated utilizing an artistic image neural network after ten iterations and twenty iterations. As shown in FIG. 7C, the resulting artistic digital image incorporates significantly more stylistic elements when both the fractal noise and the augmentation chain is used. Even those artistic digital images resulting from use of the fractal noise without the augmentation chain or vice versa appear more stylistic than the artistic digital image that results when neither is used. Accordingly, the graphical representations illustrated in FIG. 7C indicate that the artistic image neural network converges (i.e., incorporates the style parameters) more quickly when fractal noise and/or an augmentation chain is used.

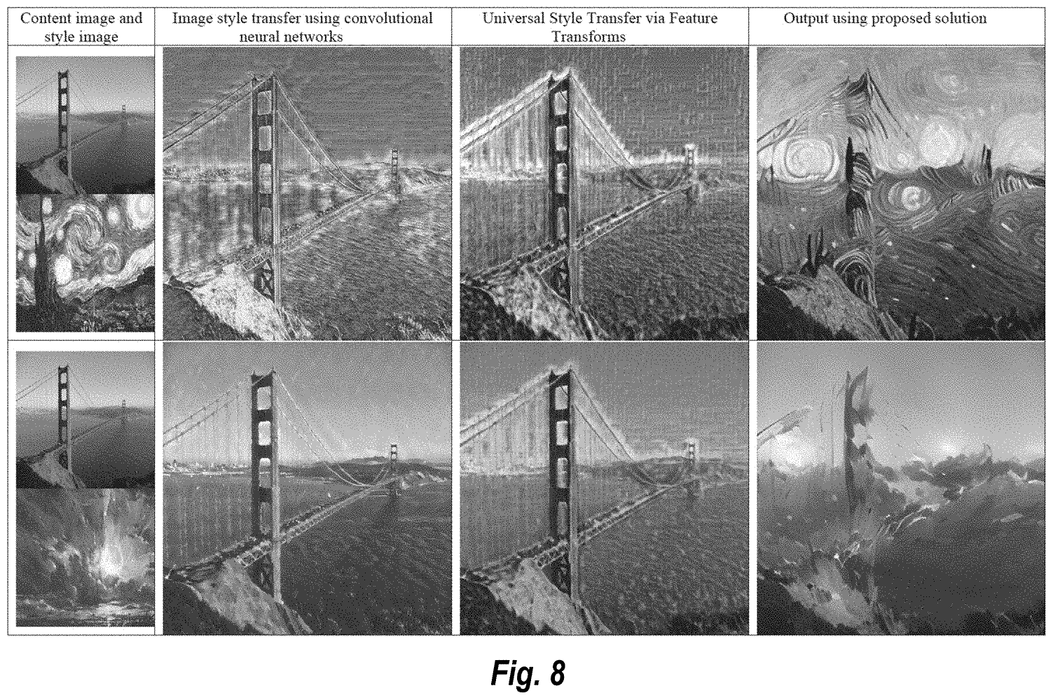

As previously mentioned, the artistic content generation system 106 enables implementing computing devices to more accurately and flexibly incorporate style parameters into artistic digital images when compared to conventional studies. Researchers have conducted studies to determine the accuracy and flexibility of one or more embodiments of the artistic content generation system 106. FIGS. 8-10 illustrate graphical representations reflecting experimental results regarding the effectiveness of the artistic content generation system 106 in accordance with one or more embodiments.

For example, FIG. 8 illustrates artistic digital images generated by one or more embodiments of the artistic content generation system 106 based on a style digital image and a digital image having content for the artistic digital image. The graphical representations of FIG. 8 compare the performance of the artistic content generation system 106 to the performance a system performing image style transfer using convolutional neural networks as described by Leon A Gatys et al., Image Style Transfer Using Convolutional Neural Networks, CVPR, pp. 2414-2423, arXiv:1508.06576, 2016. The graphical representations further illustrate the performance of a system implementing universal style transfer via feature transforms as described by Yijun Li et al., Universal Style Transfer via Feature Transforms, NIPS, 2017, arXiv:1705.08086.

As shown in FIG. 8, the artistic content generation system 106 generates artistic digital images that more accurately capture the style parameters provided by the respective style digital images. For instance, the artistic content generation system 106 alters the structure of the provided content to more closely adhere to the artistic style presented in the style digital image.

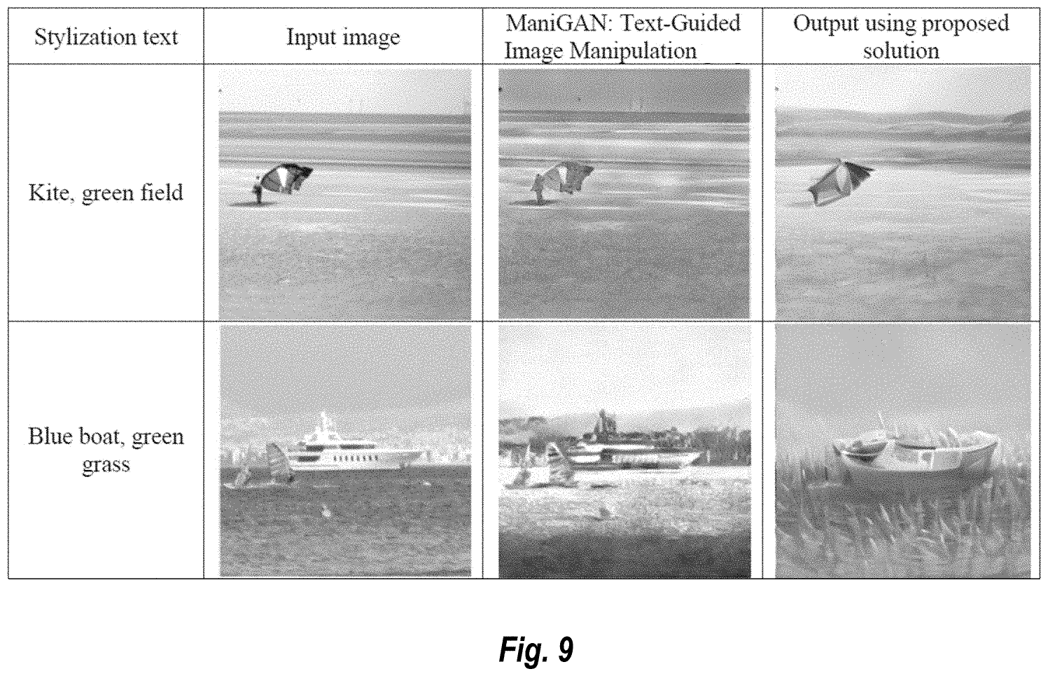

FIG. 9 illustrates artistic digital images generated by one or more embodiments of the artistic content generation system 106 based on a style text prompt and a digital image having content for the artistic digital image. The graphical representations of FIG. 9 compare the performance of the artistic content generation system 106 to the performance of a system implementing text-guided image manipulation described by Bowen Li et al., ManiGAN: Text-Guided Image Manipulation, CVPR, 2020, arXiv:1912.06203.

As shown in FIG. 9, the artistic content generation system 106 generates artistic digital images more flexibly than the other tested system. Indeed, the artistic content generation system 106 utilizes the style text prompt to modify the structure of the provided content and incorporate the corresponding style parameters. Comparatively, the resulting image generated by the other system provides a photorealistic representation of the provided content with minor variations to color, texture, or background.

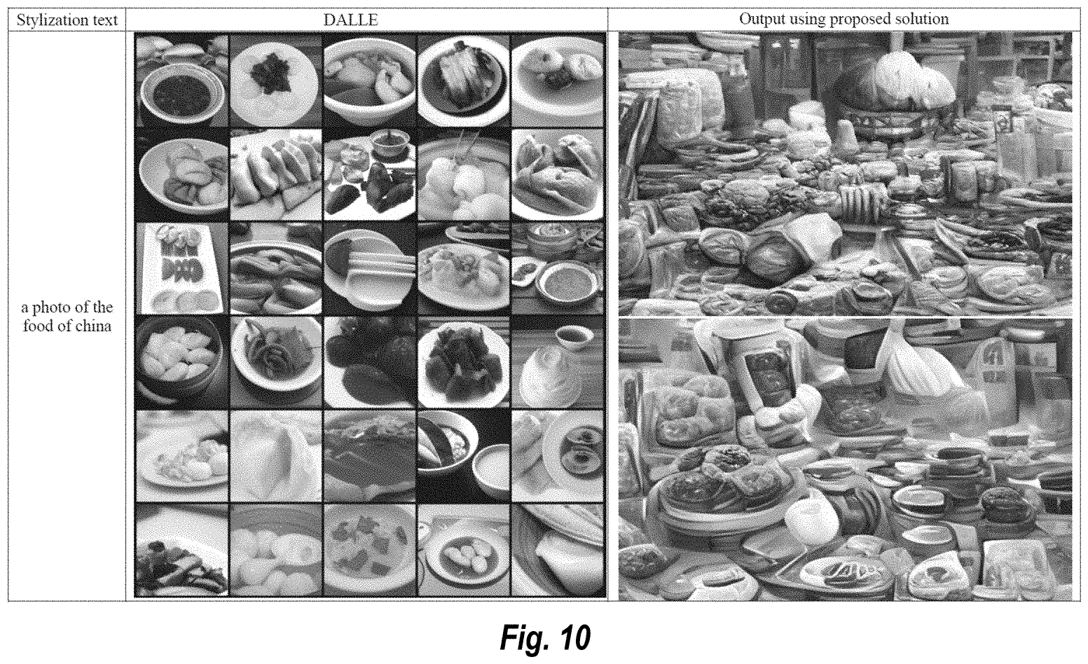

FIG. 10 illustrates artistic digital images generated by one or more embodiments of the artistic content generation system 106 based on a style text prompt. The graphical representations of FIG. 9 compare the performance of the artistic content generation system 106 to the performance of the DALL-E model as described in Open AI Blog, DALL-E. Creating Images from Text, 5 Jan. 2021, https://openai.com/blog/dall-e. As with FIG. 9, the graphical representations of FIG. 10 illustrate the flexibility of the artistic content generation system 106 as it can generate artistic digital images solely based on text style prompts while the other model merely generates photo-realistic representations.

Turning now to FIG. 11, additional detail will now be provided regarding various components and capabilities of the artistic content generation system 106. In particular, FIG. 11 illustrates the artistic content generation system 106 implemented by the computing device 1100 (e.g., the server(s) 102 and/or one of the client devices 110a-110b discussed above with reference to FIG. 1). Additionally, the artistic content generation system 106 is also part of the image editing system 104. As shown in FIG. 11, the artistic content generation system 106 includes, but is not limited to, a neural network training engine 1102, a neural network application manager 1104, and data storage 1106 (which includes artistic image neural network 1108 and training data 1110).

As just mentioned, and as illustrated in FIG. 11, the artistic content generation system 106 includes the neural network training engine 1102. In one or more embodiments, the neural network training engine 1102 trains an artistic image neural network to generate artistic digital images from style digital images, style text prompts, and/or digital image providing content for the artistic digital images. In particular, in some implementations, the neural network training engine 1102 trains one or more artistic superzoom neural networks of an artistic image neural network to increase the resolution of an image input and/or add one or more art details associated with a physical visual medium.

Further, as shown in FIG. 11, the artistic content generation system 106 includes the neural network application manager 1104. In one or more embodiments, the neural network application manager 1104 utilizes the artistic image neural network trained by the neural network training engine 1102 to generate artistic digital images. For instance, in some cases, the neural network application manager 1104 utilizes the artistic image neural network to generate an artistic digital image that incorporates style parameters from at least one style digital image and/or at least one style text prompt. Further, in some cases, the neural network application manager 1104 utilizes the artistic image neural network to generate an artistic digital image having content from another digital image.

Additionally, as shown, the artistic content generation system 106 includes data storage 1106. In particular, data storage 1106 (implemented by one or more memory devices) includes artistic image neural network 1108 and training data 1110. In one or more embodiments, the artistic image neural network 1108 stores the artistic image neural network trained by the neural network training engine 1102 and utilized by the neural network application manager 1104. In some cases, training data 1110 stores the training data utilized by the neural network training engine 1102 to train an artistic image neural network. For instance, in some implementations, training data 1110 stores the images of paintings utilized to train the one or more artistic superzoom neural networks of the artistic image neural network. The data storage 1106 can also include input digital images, style parameters (e.g., style images and/or text prompts), and artistic digital images.

Each of the components 1102-1110 of the artistic content generation system 106 can include software, hardware, or both. For example, the components 1102-1110 can include one or more instructions stored on a computer-readable storage medium and executable by processors of one or more computing devices, such as a client device or server device. When executed by the one or more processors, the computer-executable instructions of the artistic content generation system 106 can cause the computing device(s) to perform the methods described herein. Alternatively, the components 1102-1110 can include hardware, such as a special-purpose processing device to perform a certain function or group of functions. Alternatively, the components 1102-1110 of the artistic content generation system 106 can include a combination of computer-executable instructions and hardware.

Furthermore, the components 1102-1110 of the artistic content generation system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1102-1110 of the artistic content generation system 106 may be implemented as a stand-alone application, such as a desktop or mobile application. Furthermore, the components 1102-1110 of the artistic content generation system 106 may be implemented as one or more web-based applications hosted on a remote server. Alternatively, or additionally, the components 1102-1110 of the artistic content generation system 106 may be implemented in a suite of mobile device applications or “apps.” For example, in one or more embodiments, the artistic content generation system 106 can comprise or operate in connection with digital software applications such as ADOBE® PHOTOSHOP®, ADOBE® AFTER EFFECTS®, or ADOBE® ILLUSTRATOR®. The foregoing are either registered trademarks or trademarks of Adobe Inc. in the United States and/or other countries.

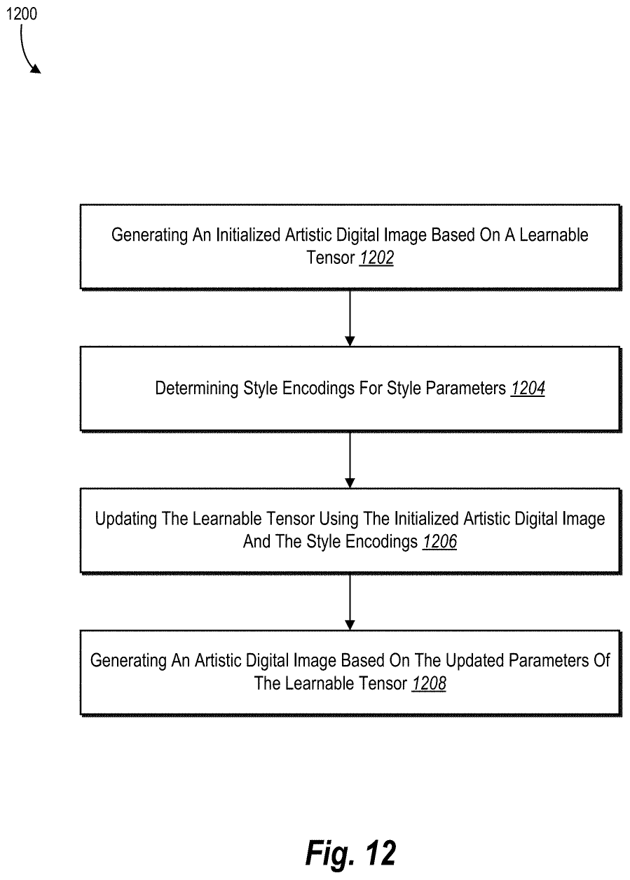

FIGS. 1-11, the corresponding text, and the examples provide a number of different methods, systems, devices, and non-transitory computer-readable media of the artistic content generation system 106. In addition to the foregoing, one or more embodiments can also be described in terms of flowcharts comprising acts for accomplishing the particular result, as shown in FIG. 12. FIG. 12 may be performed with more or fewer acts. Further, the acts may be performed in different orders. Additionally, the acts described herein may be repeated or performed in parallel with one another or in parallel with different instances of the same or similar acts.

FIG. 12 illustrates a flowchart of a series of acts 1200 for generating an artistic digital image utilizing an artistic image neural network in accordance with one or more embodiments. FIG. 12 illustrates acts according to one embodiment, alternative embodiments may omit, add to, reorder, and/or modify any of the acts shown in FIG. 12. In some implementations, the acts of FIG. 12 are performed as part of a method. For example, in some embodiments, the acts of FIG. 12 are performed, in a digital medium environment for creating digital content, as part of a computer-implemented method for generating digital visual art. Alternatively, a non-transitory computer-readable medium can store instructions thereon that, when executed by at least one processor, cause a computing device to perform operations comprising the acts of FIG. 12. In some embodiments, a system performs the acts of FIG. 12. For example, in one or more embodiments, a system includes one or more memory devices comprising an artistic image neural network that includes an artistic generative neural network, a learnable tensor, and an artistic superzoom neural network. The system further includes one or more server devices configured to cause the system to perform the acts of FIG. 12.

The series of acts 1200 includes an act 1202 for generating an initialized artistic digital image based on a learnable tensor. For example, in some embodiments, the act 1202 involves generating, utilizing an artistic generative neural network of an artistic image neural network, an initialized artistic digital image based on a learnable tensor.

In one or more embodiments, the artistic content generation system 106 receives a digital image comprising content for creating the artistic digital image and initializes the parameters of the learnable tensor based on the digital image utilizing an encoder of the artistic generative neural network. Accordingly, in some instances, the artistic content generation system 106 generates, utilizing the artistic generative neural network, the initialized artistic digital image based on the learnable tensor by generating, utilizing a decoder of the artistic generative neural network, the initialized artistic digital image based on the learnable tensor with the initialized parameters. In some implementations, the artistic content generation system 106 modifies the digital image utilizing fractal noise and initializes the parameters of the learnable tensor based on the digital image utilizing the encoder of the artistic generative neural network by initializing the parameters of the learnable tensor based on the digital image with the fractal noise utilizing the encoder of the artistic generative neural network.

Additionally, the series of acts 1200 include an act 1204 for determining style encodings for style parameters. For instance, in some cases, the act 1204 involves determining, utilizing a multi-domain style encoder of the artistic image neural network, one or more style encodings for one or more style parameters.

In some implementations, the artistic content generation system 106 receives at least one of a style digital image that includes the one or more style parameters or a style text prompt that includes the one or more style parameters. Accordingly, in some cases, the artistic content generation system 106 determines the one or more style encodings for the one or more style parameters by generating the one or more style encodings within a multi-domain encoding space from the at least one of the style digital image or the style text prompt utilizing the multi-domain style encoder.

The series of acts 1200 also includes an act 1206 of updating the learnable tensor using the initialized artistic digital image and the style encodings. To illustrate, in some instances, the act 1206 involves updating parameters of the learnable tensor by comparing the initialized artistic digital image to the one or more style encodings.

In one or more embodiments, the artistic content generation system 106 modifies the initialized artistic digital image utilizing an augmentation chain of transformation operations. Accordingly, in some cases, the artistic content generation system 106 compares the initialized artistic digital image to the one or more style encodings by comparing the modified initialized artistic digital image to the one or more style encodings.

Further, in some cases, the artistic content generation system 106 generates artistic encodings within a multi-domain encoding space from the initialized artistic digital image utilizing a neural network image encoder; and compares the initialized artistic digital image to the one or more style encodings by comparing the artistic encodings to the one or more style encodings within the multi-domain encoding space.

Further, the series of acts 1200 includes an act 1208 of generating an artistic digital image based on the updated parameters of the learnable tensor. For example, in one or more embodiments, the act 1208 involves generating, utilizing the artistic generative neural network, an artistic digital image based on the learnable tensor with the updated parameters.

In one or more embodiments, the artistic content generation system 106 further modifies the parameters of the learnable tensor. For instance, in some cases, the artistic content generation system 106 modifies the updated parameters of the learnable tensor by utilizing a plurality of iterations to: generate, utilizing the artistic generative neural network, an intermediate artistic digital image based on the learnable tensor with the updated parameters; and modify the updated parameters of the learnable tensor based on comparing the intermediate artistic digital image to the one or more style encodings. Accordingly, in some embodiments, the artistic content generation system 106 generates the artistic digital image based on the learnable tensor with the updated parameters by generating the artistic digital image based on learnable tensor with the modified parameters.

In some cases, the artistic content generation system 106 utilizes the plurality of iterations to generate, utilizing the artistic generative neural network, the intermediate artistic digital image by: generating, via a first set of iterations and utilizing the artistic generative neural network, a first set of intermediate artistic digital images corresponding to a first image resolution; and generating, via a second set of iterations and utilizing the artistic generative neural network, a second set of intermediate artistic digital images corresponding to a second image resolution.

In some embodiments, the series of acts 1200 further includes acts for modifying the artistic digital image. For instance, in some cases, the acts include modifying the artistic digital image to include one or more art details associated with a physical visual medium utilizing an artistic superzoom neural network.

To provide an illustration, in one or more embodiments, the artistic content generation system 106 receives a set of style parameters for creating an artistic digital image; and generates the artistic digital image utilizing the set of style parameters by iteratively: generating an intermediate artistic digital image based on the learnable tensor utilizing the artistic generative neural network of an artistic image neural network; comparing the intermediate artistic digital image to the set of style parameters; and updating parameters of the learnable tensor based on comparing the intermediate artistic digital image to the set of style parameters. Further, the artistic content generation system 106 modifies the artistic digital image to include one or more art details associated with a physical visual medium utilizing the artistic superzoom neural network of the artistic image neural network.

In some cases, the artistic content generation system 106 receives the set of style parameters for creating the artistic digital image by receiving one or more style digital images that include style parameters and one or more style text prompts that include additional style parameters. Additionally, in some embodiments, the artistic content generation system 106 initializes the parameters of the learnable tensor by selecting a point within an encoding space associated with the artistic generative neural network.

In one or more embodiments, the artistic content generation system 106 further generates the artistic digital image utilizing the set of style parameters by iteratively: modifying the intermediate artistic digital image utilizing an augmentation chain of transformation operations comprising at least one of a resize operation, a crop operation, a perspective operation, an image flip operation, or a noise operation; and comparing the intermediate artistic digital image to the set of style parameters by comparing the modified intermediate artistic digital image to the set of style parameters.

In some cases, the artistic content generation system 106 utilizes various sets of iterations in generating the artistic digital image. For instance, in some embodiments, the artistic content generation system 106 generates the artistic digital image utilizing the set of style parameters by: generating, via a first set of iterations and utilizing the artistic generative neural network, a first set of intermediate artistic digital images corresponding to a first image resolution; and generating, via a second set of iterations and utilizing the artistic generative neural network, a second set of intermediate artistic digital images corresponding to a second image resolution that is higher than the first image resolution.

In some cases, the artistic content generation system 106 receives a digital image comprising content for creating the artistic digital image. Accordingly, in some implementations, the artistic content generation system 106 generates the first set of intermediate artistic digital images utilizing the digital image at the first image resolution; and up-samples an intermediate artistic digital image from the first set of intermediate artistic digital images for use in the second set of iterations utilizing an additional artistic superzoom neural network. In some embodiments, the artistic content generation system 106 modifies the digital image for use in the first set of iterations utilizing fractal noise; and modifies the intermediate artistic digital image from the first set of intermediate artistic digital images for use in the second set of iterations utilizing additional fractal noise.

In one or more embodiments, the artistic content generation system 106 compares the intermediate artistic digital image to the set of style parameters by comparing the intermediate artistic digital image to the set of style parameters utilizing a style loss and at least one of a pixel loss or a perceptual loss corresponding to a digital image comprising content for creating the artistic digital image.

To provide another illustration, in one or more embodiments, the artistic content generation system 106 receives, from a computing device, a digital image and one or more style parameters comprising at least one of a style digital image or a style text prompt; determines one or more style encodings for the one or more style parameters; iteratively utilizes the one or more style encodings to generate an artistic digital image from the digital image; and provides the artistic digital image for display via the computing device.

In some implementations, the artistic content generation system 106 receives the one or more style parameters comprising the at least one of the style digital image or the style text prompt by receiving the style digital image. Accordingly, in some cases, the artistic content generation system 106 further generates a set of transformed style digital images from the style digital image by cropping the style digital image utilizing at least one of a variable cropping size or a variable cropping offset. Further, in some instances, the artistic content generation system 106 determining the one or more style encodings for the one or more style parameters by determining a plurality of style encodings from the set of transformed style digital images.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 13 illustrates a block diagram of an example computing device 1300 that may be configured to perform one or more of the processes described above. One will appreciate that one or more computing devices, such as the computing device 1300 may represent the computing devices described above (e.g., the server(s) 102 and/or the client devices 110a-110b). In one or more embodiments, the computing device 1300 may be a mobile device (e.g., a mobile telephone, a smartphone, a PDA, a tablet, a laptop, a camera, a tracker, a watch, a wearable device). In some embodiments, the computing device 1300 may be a non-mobile device (e.g., a desktop computer or another type of client device). Further, the computing device 1300 may be a server device that includes cloud-based processing and storage capabilities.

As shown in FIG. 13, the computing device 1300 can include one or more processor(s) 1302, memory 1304, a storage device 1306, input/output interfaces 1308 (or “I/O interfaces 1308”), and a communication interface 1310, which may be communicatively coupled by way of a communication infrastructure (e.g., bus 1312). While the computing device 1300 is shown in FIG. 13, the components illustrated in FIG. 13 are not intended to be limiting. Additional or alternative components may be used in other embodiments. Furthermore, in certain embodiments, the computing device 1300 includes fewer components than those shown in FIG. 13. Components of the computing device 1300 shown in FIG. 13 will now be described in additional detail.

In particular embodiments, the processor(s) 1302 includes hardware for executing instructions, such as those making up a computer program. As an example, and not by way of limitation, to execute instructions, the processor(s) 1302 may retrieve (or fetch) the instructions from an internal register, an internal cache, memory 1304, or a storage device 1306 and decode and execute them.

The computing device 1300 includes memory 1304, which is coupled to the processor(s) 1302. The memory 1304 may be used for storing data, metadata, and programs for execution by the processor(s). The memory 1304 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1304 may be internal or distributed memory.

The computing device 1300 includes a storage device 1306 including storage for storing data or instructions. As an example, and not by way of limitation, the storage device 1306 can include a non-transitory storage medium described above. The storage device 1306 may include a hard disk drive (HDD), flash memory, a Universal Serial Bus (USB) drive or a combination these or other storage devices.

As shown, the computing device 1300 includes one or more I/O interfaces 1308, which are provided to allow a user to provide input to (such as user strokes), receive output from, and otherwise transfer data to and from the computing device 1300. These I/O interfaces 1308 may include a mouse, keypad or a keyboard, a touch screen, camera, optical scanner, network interface, modem, other known I/O devices or a combination of such I/O interfaces 1308. The touch screen may be activated with a stylus or a finger.

The I/O interfaces 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1308 are configured to provide graphical data to a display for presentation to a user. The graphical data may be representative of one or more graphical user interfaces and/or any other graphical content as may serve a particular implementation.

The computing device 1300 can further include a communication interface 1310. The communication interface 1310 can include hardware, software, or both. The communication interface 1310 provides one or more interfaces for communication (such as, for example, packet-based communication) between the computing device and one or more other computing devices or one or more networks. As an example, and not by way of limitation, communication interface 1310 may include a network interface controller (NIC) or network adapter for communicating with an Ethernet or other wire-based network or a wireless NIC (WNIC) or wireless adapter for communicating with a wireless network, such as a WI-FI. The computing device 1300 can further include a bus 1312. The bus 1312 can include hardware, software, or both that connects components of computing device 1300 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A non-transitory computer-readable medium storing instructions thereon that, when executed by at least one processor, cause a computing device to perform operations comprising:
generating, utilizing an artistic generative neural network of an artistic image neural network, an initialized artistic digital image based on a learnable tensor;
determining, utilizing a multi-domain style encoder of the artistic image neural network, one or more style encodings for one or more style parameters;
updating parameters of the learnable tensor by comparing the initialized artistic digital image to the one or more style encodings; and
generating, utilizing the artistic generative neural network, an artistic digital image based on the learnable tensor with the updated parameters.

2. The non-transitory computer-readable medium of claim 1, further comprising instructions that, when executed by the at least one processor, cause the computing device to perform operations comprising modifying the artistic digital image to include one or more art details associated with a physical visual medium utilizing an artistic superzoom neural network.

3. The non-transitory computer-readable medium of claim 1, further comprising perform operations comprising:
modifying the updated parameters of the learnable tensor by utilizing a plurality of iterations to:
generate, utilizing the artistic generative neural network, an intermediate artistic digital image based on the learnable tensor with the updated parameters; and
modify the updated parameters of the learnable tensor based on comparing the intermediate artistic digital image to the one or more style encodings; and
generating the artistic digital image based on the learnable tensor with the updated parameters by generating the artistic digital image based on learnable tensor with the modified parameters.

4. The non-transitory computer-readable medium of claim 3, further comprising instructions that, when executed by the at least one processor, cause the computing device to perform operations comprising utilizing the plurality of iterations to generate, utilizing the artistic generative neural network, the intermediate artistic digital image by:
generating, via a first set of iterations and utilizing the artistic generative neural network, a first set of intermediate artistic digital images corresponding to a first image resolution; and
generating, via a second set of iterations and utilizing the artistic generative neural network, a second set of intermediate artistic digital images corresponding to a second image resolution.

5. The non-transitory computer-readable medium of claim 1, further comprising perform operations comprising:
modifying the initialized artistic digital image utilizing an augmentation chain of transformation operations; and
comparing the initialized artistic digital image to the one or more style encodings by comparing the modified initialized artistic digital image to the one or more style encodings.

6. The non-transitory computer-readable medium of claim 1, further comprising instructions that, when executed by the at least one processor, cause the computing device to perform operations comprising:
receiving a digital image comprising content for creating the artistic digital image;
initializing the parameters of the learnable tensor based on the digital image utilizing an encoder of the artistic generative neural network; and
generating, utilizing the artistic generative neural network, the initialized artistic digital image based on the learnable tensor by generating, utilizing a decoder of the artistic generative neural network, the initialized artistic digital image based on the learnable tensor with the initialized parameters.

7. The non-transitory computer-readable medium of claim 6, further comprising perform operations comprising:
modifying the digital image utilizing fractal noise; and
initializing the parameters of the learnable tensor based on the digital image utilizing the encoder of the artistic generative neural network by initializing the parameters of the learnable tensor based on the digital image with the fractal noise utilizing the encoder of the artistic generative neural network.

8. The non-transitory computer-readable medium of claim 1, further comprising instructions that, when executed by the at least one processor, cause the computing device to perform operations comprising:
receiving at least one of a style digital image that includes the one or more style parameters or a style text prompt that includes the one or more style parameters; and
determining the one or more style encodings for the one or more style parameters by generating the one or more style encodings within a multi-domain encoding space from the at least one of the style digital image or the style text prompt utilizing the multi-domain style encoder.

9. The non-transitory computer-readable medium of claim 1, further comprising perform operations comprising:
generating artistic encodings within a multi-domain encoding space from the initialized artistic digital image utilizing a neural network image encoder; and
comparing the initialized artistic digital image to the one or more style encodings by comparing the artistic encodings to the one or more style encodings within the multi-domain encoding space.

10. A system comprising:
one or more memory devices comprising an artistic image neural network that includes an artistic generative neural network, a learnable tensor, and an artistic superzoom neural network; and
one or more server devices configured to cause the system to:
receive a set of style parameters for creating an artistic digital image;
generate the artistic digital image utilizing the set of style parameters by iteratively:
generating an intermediate artistic digital image based on the learnable tensor utilizing the artistic generative neural network;
comparing the intermediate artistic digital image to the set of style parameters; and
updating parameters of the learnable tensor based on comparing the intermediate artistic digital image to the set of style parameters; and
modifying the artistic digital image to include one or more art details associated with a physical visual medium utilizing the artistic superzoom neural network.

11. The system of claim 10, wherein the one or more server devices are configured to cause the system to compare the intermediate artistic digital image to the set of style parameters by comparing the intermediate artistic digital image to the set of style parameters utilizing a style loss and at least one of a pixel loss or a perceptual loss corresponding to a digital image comprising content for creating the artistic digital image.

12. The system of claim 10, wherein the one or more server devices are further configured to cause the system to generate the artistic digital image utilizing the set of style parameters by iteratively:
modifying the intermediate artistic digital image utilizing an augmentation chain of transformation operations comprising at least one of a resize operation, a crop operation, a perspective operation, an image flip operation, or a noise operation; and
comparing the intermediate artistic digital image to the set of style parameters by comparing the modified intermediate artistic digital image to the set of style parameters.

13. The system of claim 10, wherein the one or more server devices are configured to cause the system to generate the artistic digital image utilizing the set of style parameters by:
generating, via a first set of iterations and utilizing the artistic generative neural network, a first set of intermediate artistic digital images corresponding to a first image resolution; and
generating, via a second set of iterations and utilizing the artistic generative neural network, a second set of intermediate artistic digital images corresponding to a second image resolution that is higher than the first image resolution.

14. The system of claim 13, wherein the one or more server devices are further configured to cause the system to:
receive a digital image comprising content for creating the artistic digital image;
generate the first set of intermediate artistic digital images utilizing the digital image at the first image resolution; and
up-sample an intermediate artistic digital image from the first set of intermediate artistic digital images for use in the second set of iterations utilizing an additional artistic superzoom neural network.

15. The system of claim 14, wherein the one or more server devices are further configured to cause the system to:
modify the digital image for use in the first set of iterations utilizing fractal noise; and
modify the intermediate artistic digital image from the first set of intermediate artistic digital images for use in the second set of iterations utilizing additional fractal noise.

16. The system of claim 10, wherein the one or more server devices are configured to cause the system to receive the set of style parameters for creating the artistic digital image by receiving one or more style digital images that include style parameters and one or more style text prompts that include additional style parameters.

17. The system of claim 10, wherein the one or more server devices are configured to cause the system to initialize the parameters of the learnable tensor by selecting a point within an encoding space associated with the artistic generative neural network.

18. In a digital medium environment for creating digital content, a computer-implemented method for generating digital visual art comprising:
receiving, from a computing device, a digital image and one or more style parameters comprising at least one of a style digital image or a style text prompt;
determining one or more style encodings for the one or more style parameters;
performing a step for iteratively utilizing the one or more style encodings to generate an artistic digital image from the digital image; and
providing the artistic digital image for display via the computing device.

19. The computer-implemented method of claim 18,
wherein receiving the one or more style parameters comprising the at least one of the style digital image or the style text prompt comprises receiving the style digital image;
further comprising generating a set of transformed style digital images from the style digital image by cropping the style digital image utilizing at least one of a variable cropping size or a variable cropping offset.

20. The computer-implemented method of claim 19, wherein determining the one or more style encodings for the one or more style parameters comprises determining a plurality of style encodings from the set of transformed style digital images.
